(19) United States
(12) Patent Application Publication
(10) Pub. No.: US 2025/0379043 A1
(43) Pub. Date: Dec. 11, 2025

(54) SENSITIVE AND ACCURATE FEATURE VALUES FROM DEEP MALDI SPECTRA

(71) Applicant: Biodesix, Inc., Boulder, CO (US)

(72) Inventors: Heinrich Roder, Steamboat Springs, CO (US); Matthew Koc, Broomfield, CO (US)

(21) Appl. No.: 18/730,197

(22) PCT Filed: Jan. 20, 2023
(86) PCT No.: PCT/US23/60994

§ 371 Date: Jul. 18, 2024

Related U.S. Application Data
(60) Provisional application No. 63/301,825, filed on Jan. 21, 2022.
(60) Provisional application No. 63/304,107, filed on Jan. 28, 2022.

(51) Int. Cl. H01J 49/00; H01J 49/16

(52) U.S. Cl. CPC H01J 49/0036; H01J 49/164

(57) ABSTRACT

Determination of sensitive and accurate feature values from a matrix-assisted laser desorption/ionization (MALDI) spectrum of a sample is provided. A peak shape function of the mass spectrometer is read. A fine structure component is determined for a first range of the mass spectrum by estimating and subtracting a first background from the mass spectrum. A bump structure is determined for the first range by estimating a second background, which is stiffer than the first background, and subtracting it from the first background. A convolution of the fine structure component is computed for the first range of the mass spectrum with the peak shape function. A first plurality of peaks in the first range is determined from the convolution. A feature value indicative of an abundance associated with each of the first plurality of peaks is determined by combining the first plurality of peaks with the bump structure.

### CROSS-REFERENCE TO RELATED APPLICATIONS

This application claims the benefit of U.S. Provisional Application No. 63/304,107, filed Jan. 28, 2022 and U.S. Provisional Application No. 63/301,825, filed Jan. 21, 2022, each of which are hereby incorporated by reference in their entirety.

### BACKGROUND

Embodiments of the present disclosure relate to mass spectrometry, and more specifically, to determining sensitive and accurate feature values from matrix-assisted laser desorption/ionization (MALDI) spectra, for example of complex biological samples like serum or plasma.

### BRIEF SUMMARY

According to embodiments of the present disclosure, methods of and computer program products for extracting a plurality of feature values from a mass spectrum are provided. A mass spectrum of a sample is read, originating from a matrix-assisted laser desorption/ionization (MALDI) mass spectrometer. A peak shape function of the mass spectrometer is read. A fine structure component is determined for a first range of the mass spectrum. Determining the fine structure component comprises estimating a first background of the mass spectrum and subtracting the first background from the mass spectrum. A bump structure is determined for the first range of the mass spectrum. Determining the bump structure component comprises estimating a second background of the mass spectrum, the second background being stiffer than the first background. The second background is subtracted from the first background. A convolution of the fine structure component is computed for the first range of the mass spectrum with the peak shape function. A first plurality of peaks in the first range of the mass spectrum is determined from the convolution. A feature value indicative of an abundance associated with each of the first plurality of peaks is determined. Determining the feature value comprises combining the first plurality of peaks with the bump structure.

In some embodiments, a reference peak list is read, comprising a plurality of reference peaks and the first plurality of peaks is aligned to the plurality of reference peaks.

In some embodiments, a reference peak list is read, comprising a plurality of reference peaks and a second plurality of peaks in the mass spectrum is determined by fitting the peak shape function to each of the plurality of reference peaks.

In some embodiments, estimating the first and/or second background comprises applying an asymmetric least squares fitting. In some such embodiments, estimating the first and/or second background comprises applying Eilers' estimation.

In some embodiments, a peak amplitude is determined for each of the first plurality of peaks, wherein combining the first plurality of peaks with the bump structure comprises combining the peak amplitude and an intensity of the bump structure.

In some embodiments, a peak area is determined for each of the first plurality of peaks, wherein combining the first plurality of peaks with the bump structure comprises combining the peak area and an area of the bump structure.

In some embodiments, the peak shape function is an asymmetric Gaussian. In some embodiments, reading the peak shape function comprises reading a plurality of coefficients of the asymmetric Gaussian. In some embodiments, determining the first plurality of peaks comprises simultaneously fitting the peak shape function to a plurality of peak candidates in parallel. In some embodiments, determining the first plurality of peaks comprises identifying a plurality of clusters of candidate peaks and simultaneously fitting the peak shape function to each peak candidates in at least one of the plurality of clusters in parallel. In some embodiments, identifying the plurality of clusters comprises selecting candidate peaks having peak centers within a predetermined distance of each other. In some embodiments, the predetermined distance is a half peak-width. In some embodiments, identifying the plurality of clusters comprises selecting candidate peaks intersecting each other at greater than a threshold amplitude. In some embodiments, the threshold amplitude is a predetermined fraction of a maximum amplitude. In some embodiments, the predetermined fraction is 10%.

In some embodiments, determining the first plurality of peaks comprises filtering candidate peaks according to a predetermined SNR threshold.

In some embodiments, determining the first plurality of peaks comprises performing median absolute deviation (MAD) fitting.

In some embodiments, the MALDI mass spectrometer is a MALDI-time-of-flight (MALDI-TOF) mass spectrometer. In some embodiments, reading the mass spectrum comprises performing Deep MALDI.

In some embodiments, each feature value corresponds to peak amplitude.

In some embodiments, a baseline background of the mass spectrum is estimated and the background is subtracted therefrom. In some embodiments, estimating the baseline background comprises applying an asymmetric least squares fitting. In some embodiments, estimating the baseline background comprises applying Eilers' estimation.

According to embodiments of the present disclosure, methods of and computer program products for disease detection are provided. A plurality of feature values is determined from a mass spectrum according to any of the foregoing methods, wherein the sample is a biological sample of a subject. The plurality of feature values is provided to a trained classifier, and an indication is received therefrom of the presence of a disease condition in the subject.

According to embodiments of the present disclosure, methods of and computer program products for training a classifier are provided. A plurality of feature values is determined from a mass spectrum according to any of the foregoing methods, wherein the sample is a biological sample of a subject. A classifier is trained to provide an indication of the presence of a disease condition in the subject based on the plurality of feature values.

According to embodiments of the present disclosure, systems for extracting a plurality of feature values from a mass spectrum are provided. Such systems comprise a mass spectrometer and a computing node operatively coupled to the mass spectrometer and comprising a computer readable storage medium having program instructions embodied therewith, the program instructions executable by a processor of the computing node to cause the processor to perform any of the foregoing methods.

### BRIEF DESCRIPTION OF THE SEVERAL VIEWS OF THE DRAWINGS

FIG. 1A is a flowchart illustrating a method of generating a peak list from mass spectrometer data according to embodiments of the present disclosure.

FIG. 1B is a flowchart illustrating a method of feature extraction from mass spectrometer data according to embodiments of the present disclosure.

FIG. 2 is a graph of example spectra according to embodiments of the present disclosure.

FIGS. 3A-B are graphs showing an example spectral component analysis according to embodiments of the present disclosure.

FIGS. 4A-B are graphs illustrating peak shape determination of MALDI-TOF spectral peaks according to embodiments of the present disclosure together with error estimates.

FIG. 5 is graph showing an example of a 400k shot averaged Deep MALDI spectrum of a serum sample together with the estimated (Eilers') background according to embodiments of the present disclosure.

FIGS. 6A-C are graphs illustrating peak fitting and feature value determination according to embodiments of the present disclosure.

FIGS. 7A-B are histograms illustrating reproducibility of feature values for an exemplary sample according to embodiments of the present disclosure.

FIGS. 8A-B are graphs of cumulative coefficient of variation (CV) distribution according to embodiments of the present disclosure.

FIGS. 9A-R are graphs of exemplary sub-ranges of an example serum spectrum according to embodiments of the present disclosure.

FIG. 10 is a graph of example spectra according to embodiments of the present disclosure.

FIGS. 11A-B are graphs illustrating peak shape determination of MALDI-TOF spectral peaks according to embodiments of the present disclosure together with error estimates.

FIGS. 12A-F are graphs illustrating peak shape parameter stability according to embodiments of the present disclosure.

FIG. 13 is a graph illustrating dependence of peak shape parameters on m/z assuming averagine according to embodiments of the present disclosure.

FIG. 14 depicts a computing node according to embodiments of the present disclosure.

### DETAILED DESCRIPTION

In mass spectrometry, matrix-assisted laser desorption/ionization (MALDI) is an ionization technique that uses a laser energy absorbing matrix to create ions from large molecules with minimal fragmentation. It has been applied to the analysis of biomolecules (biopolymers such as DNA, proteins, peptides and carbohydrates) and various organic molecules (such as polymers, dendrimers and other macromolecules), which tend to be fragile and fragment when ionized by more conventional ionization methods. It is similar in goals to electrospray ionization (ESI) in that both techniques are relatively soft (low fragmentation) ways of obtaining ions of large molecules in the gas phase.

MALDI methodology includes three steps. First, the sample is mixed with a suitable matrix material and applied to a metal plate. Second, a pulsed laser irradiates the sample, triggering ablation and desorption of the sample and matrix material. Third, the analyte molecules are ionized by being protonated or deprotonated in the hot plume of ablated gases, and then they can be accelerated into whichever mass spectrometer is used to analyze them.

In MALDI (matrix assisted laser desorption ionization) TOF (time-of-flight) mass spectrometry, a sample/matrix mixture is placed on a defined location (“spot”, or “sample spot” herein) on a metal plate, known as a MALDI plate. A laser beam is directed onto a location on the spot for a very brief instant (known as a “shot”), causing desorption and ionization of molecules or other components of the sample. The sample components “fly” to an ion detector. The instrument measures mass to charge ratio (m/z) and relative intensity of the components (molecules) in the sample in the form of a mass spectrum.

Typically, in a MALDI-TOF measurement, there are several hundred shots applied to each spot on the MALDI plate and the resulting spectra (one per shot) are summed or averaged to produce an overall mass spectrum for each spot. U.S. Pat. No. 7,109,491, which is hereby incorporated by reference in its entirety, discloses representative MALDI plates used in MALDI-TOF mass spectrometry. The plates include a multitude of individual locations or spots where the sample is applied to the plate, typically arranged in an array of perhaps several hundred such spots.

In DeepMALDI®, more than 20,000, and typically 100,000 to 500,000 shots from the same MALDI spot or from the combination of accumulated spectra from multiple spots of the same sample are collected and averaged many. This leads to a reduction in the relative level of noise vs. signal and a significant amount of additional spectral information from mass spectrometry of complex biological samples is revealed. The reduction of noise via averaging many shots leads to the appearance of previously invisible peaks (i.e., peaks not apparent at 1,000 shots). Using these deep-MALDI techniques, a very large number of proteins can be detected.

A variety of methods for automation of spectral acquisition may be used. Automation of the acquisition may include defining optimal movement patterns of the laser scanning of the spot in a raster fashion, and generation of a specified sequence for multiple raster scans at discrete X/Y coordinate locations within a spot to result in say 750,000 or 3,000,000 shots from one or more spots. For example, spectra acquired from 250,000 shots per each of four sample spots can be combined into a 1,000,000 shot spectrum. As mentioned previously, hundreds of thousands of shots to millions of shots collected on multiple spots containing the same sample can be averaged together to create one average spectrum.

Additional details regarding Depp MALDI are provided in U.S. Pat. No. 9,606,101, which is hereby incorporated by reference in its entirety.

Accurate and precise measurement of the relative protein content of blood-based samples using mass spectrometry is challenging due to the large number of circulating proteins and the dynamic range of their abundances. Traditional spectral processing methods often struggle with accurately detecting overlapping peaks that are observed in these samples. The present disclosure provides a novel spectral processing algorithm that effectively detects over 1650 peaks with over 3.5 orders of magnitude in intensity in the 3 to 30 kD m/z range. In various embodiments, an algorithm utilizes a convolution of the peak shape to enhance peak detection, and accurate peak fitting to provide highly reproducible relative abundance estimates for both isolated peaks and overlapping peaks.

These approaches provide a substantial increase in the reproducibility of the measurements of relative protein abundance when comparing these methods to a traditional processing method for sample sets run on multiple matrix-assisted laser desorption/ionization-time of flight (MALDI-TOF) instruments. Utilizing protein set enrichment analysis (PSEA), a sizable increase is observed in the number of features associated with biological processes compared to alternative approaches. The new processing methods improve the functioning of MALDI devices and are particularly useful for developing high performance molecular diagnostic tests in disease indications.

Protein abundance in blood is related to outcomes in many systemic diseases and cancer. Standard measurements of known (pre-defined) proteins via enzyme-linked immunoassays (ELISAs) used in medical diagnostics typically measure small numbers of proteins, sometimes in combination with clinical attributes. Due to the complexity of pathway interactions, multiplexed measurement of many proteins will allow for more accurate characterization of a patient cohort in a particular disease. Diagnostic tests can be provided based on highly sensitive high-throughput MALDI profiling, Deep MALDI analysis, which enables the simultaneous measurement of proteins varying in abundance by four orders of magnitude. These highly multiplexed data can be combined into diagnostic tests using machine learning techniques designed to work well in the clinical setting where there are generally more attributes than samples, without over-fitting.

One challenge with using MALDI profiling is the reliable definition and characterization of many hundreds to thousands of Deep MALDI peaks with a dynamic range of peak intensity varying over 4 orders of magnitude and with overlapping peaks in the presence of background and noise. Reliable and reproducible peak intensity estimates are necessary as input into machine learning algorithms. Typical peak picking approaches often miss many peaks. They often rely on simply finding candidate peaks either through local intensity maxima or by finding minima in the second derivatives of the intensity, and then using intensity thresholding to select real peaks from the selection of candidate peaks. Although this method is computationally fast, it can fail to detect peaks when they overlap and may struggle to work well when there are large changes in peak intensity. Peak detection algorithms using a continuous wavelet transform exhibit improved peak detection, but they often are not accurate in the case of overlapping peaks or highly asymmetric peaks.

To address these and other shortcomings in alternative approaches, the present disclosure provides an improved peak detection approach based on characteristics of Deep MALDI spectra. Well-defined (using the measured m/z, mass-charge ratio, dependent peak half-width) individual peaks are separated from broad structures. These well-defined peaks are then fitted using a pre-defined peak shape function either individually, when isolated, or in a multi-peak fit algorithm, when overlapping. Finally, the intensity of the broad structures is added back to the intensity of the previously estimated well-defined peaks to give an expression value for a peak.

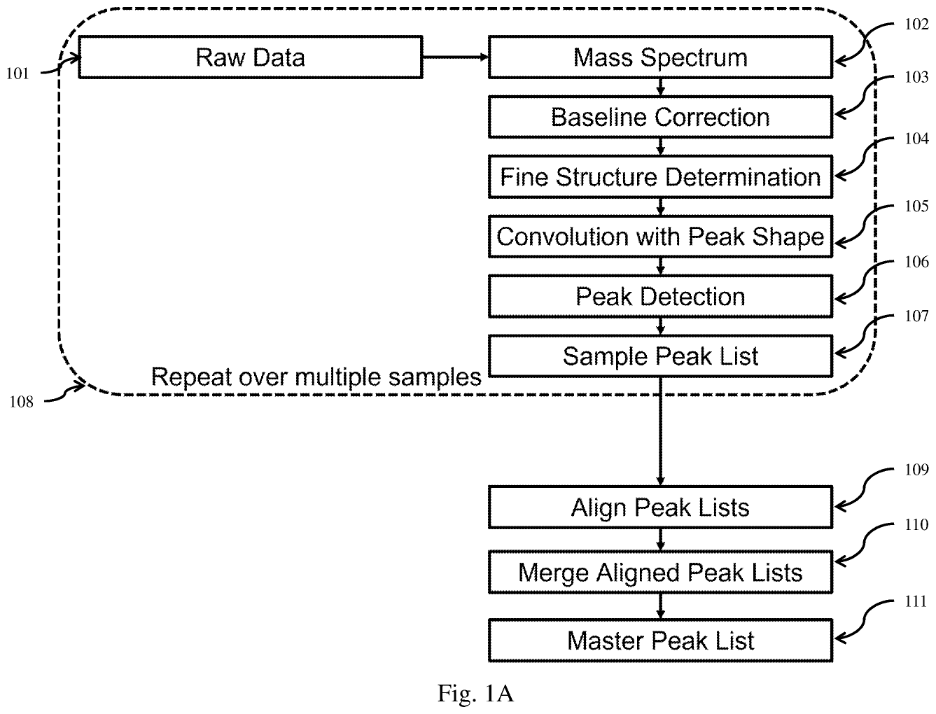

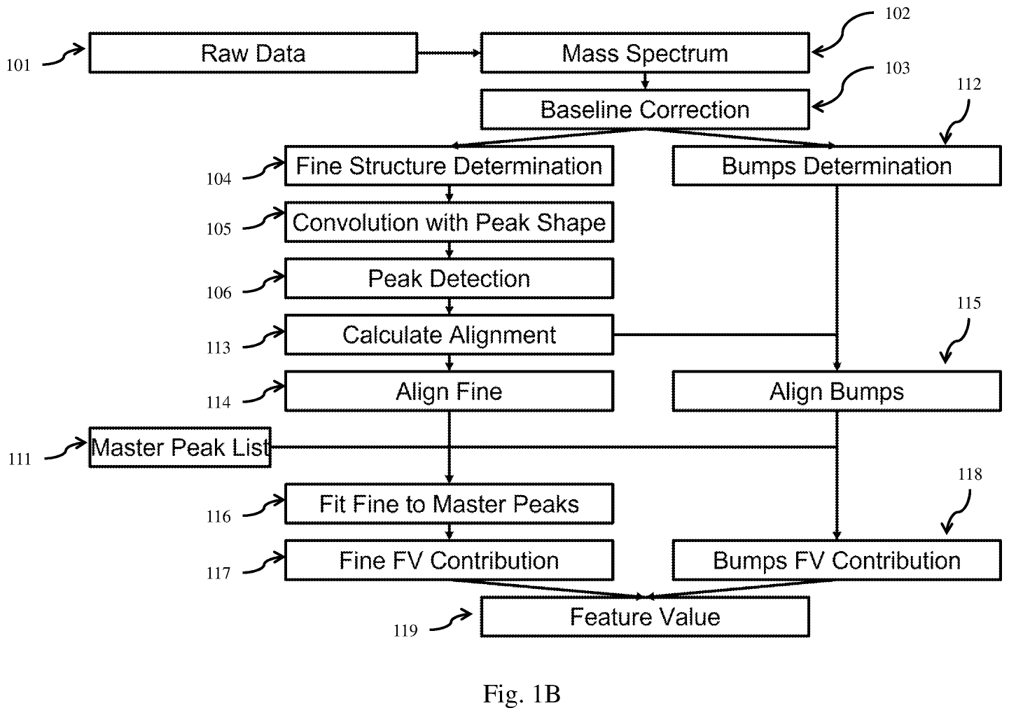

Referring to FIG. 1, spectral analysis workflows for mass spectrometer data are illustrated according to embodiments of the present disclosure. In particular, FIG. 1A illustrates a method of generating a peak list from mass spectrometer data. FIG. 1B illustrates a method of feature extraction from mass spectrometer data according.

Referring to FIG. 1A, raw data 101 are read, for example from a data store such as a database or flat file storage, or directly from a mass spectrometer such as a MALDI-TOF mass spectrometer. It will be appreciated that the representation of the raw data may take various forms according to the source instrument and industry standards, but generally include at least intensity at a set of m/z points.

A mass spectrum 102 is determined from raw data 101. In general, a mass spectrum is a list of intensities at a set of m/z values, often depicted as a plot of intensity as a function of mass-to-charge ratio. The generation of such a spectrum is achievable by various methods known in the art. It will be appreciated that Mass Spectrum 102 may be generated through the Deep MALDI process, and that such a spectrum may be referred to as a Deep MALDI Spectrum. In various embodiments, mass spectrum 102 may be read from a datastore, or may be determined by a computing node included in a mass spectrometer or external to a mass spectrometer.

As set out in more detail below, a baseline correction 103 may optionally be applied to mass spectrum 102 prior to further processing. For example, a baseline background may be determined and then subtracted from the spectrum prior to further processing. Methods suitable for estimating the baseline background include asymmetric least squares fitting and Eilers' estimation in particular. Eilers' estimation is described further in Boelens, et al., New Background Correction Method for Liquid Chromatography with Diode Array Detection, Infrared Spectroscopic Detection and Raman Spectroscopic Detection. J. Chromatogr. A 2004, 1057, 21-30, doi:10.1016/j.chroma.2004.09.035, which is hereby incorporated by reference in its entirety. However, it will be appreciated that a variety of additional methods may be used to estimate a baseline background for correction.

A fine structure component is determined 104 based on the mass spectrum (as optionally corrected in at 103). Determining the fine structure component includes estimating a first background of the mass spectrum and subtracting the first background from the mass spectrum. The first background may in some embodiments be the same baseline background noted above. However, the first background may be separately determined using a different method, or the baseline background may be omitted entirely. Methods suitable for estimating the first background include asymmetric least squares fitting and Eilers' estimation in particular. However, it will be appreciated that a variety of additional methods may be used to estimate a first background.

A convolution 105 of the spectrum is performed with a peak shape. The peak shape is instrument-specific and may be read from a datastore or may be provided directly from a mass spectrometer at the time that data is collected. The peak shape may be given as a parameterized function such as an asymmetric Gaussian where the parameters are instrument-specific. For example, a mass spectrometer may be tested prior to shipping to determine a peak shape for that instrument and a digital representation of the peak shape provided with the instrument. Such a digital representation may include the coefficients of an asymmetric Gaussian.

As set out below, the convolution may be performed after extracting a fine structure component and/or bump structure component of the spectrum. In such cases, a convolution of the fine structure component is computed with the peak shape.

Peaks are detected 106 in the spectrum after performing the above-provided steps. Methods suitable for peak detection include performing median absolute deviation (MAD) fitting. However, a variety of peak fitting methods known in the art may be employed. The result of peak detection 106 is a peak list 107, which is suitable for further processing. In some embodiments, the above steps are repeated over multiple samples 108 in order to generate multiple peak lists for merging into a master peak list as described below.

Spectral alignment 109 is performed between the various peak lists. Produced in repeated process 108. In some embodiments, the peak lists are aligned to each other. In some embodiments, the peaks in each list are aligned to one or more reference peak. For example, a reference peak list may be read from a computer-readable medium, comprising a plurality of reference peaks. The extracted peaks may then be aligned to the reference peaks.

A master peak list 111 is determined by merging 110 the aligned peak lists 109. The master peak list represents a reference set of all peaks likely to be located in a sample, and may be used as set forth below for feature extraction. The master peak list may be stored for future retrieval, and need not be regenerated for each sample run.

Referring now to FIG. 1B, feature extraction from mass spectrometer data is illustrated. Steps 101 . . . 106 proceed as set forth above with respect to a new sample.

In addition to determining fine structure 104, bump structure is also determined 112 from the optionally corrected spectrum. Determining the bump structure includes estimating a second background of the mass spectrum, the second background being stiffer than the first background, and subtracting the second background from the first background. Methods suitable for estimating the second background include asymmetric least squares fitting and Eilers' estimation in particular. However, it will be appreciated that a variety of additional methods may be used to estimate a second background.

As used herein, the terms “stiff” and “relaxed” refer to the relative variation of a background or fitted curve. A “stiff” background or fitted curve has less variation than a “relaxed” background or fitted curve, thus appearing flatter. It will be appreciated that the parameters of a background determination or curve fitting may be varied to achieve a stiffer or more relaxed result in a manner known in the art.

An alignment is calculated 113 for the peak list resulting from peak detection 106. Alignment may be computed as set forth above with regard to step 109. Once an alignment is computed, this correction is applied to both the extracted fine component 114 and to the extracted bump component 115.

Based on the master peak list 111 determined above, a fit of the fine component to the master peak list 116 is performed. This fine structure fitting may include reading the master peak list (or list of reference peaks) comprising a plurality of reference peaks (whether the same list used for alignment, or a different list). Additional peaks are determined in the mass spectrum by fitting the peak shape to each of the plurality of reference peaks. Where peaks appear in a cluster, the peak shape function may be simultaneously fit to a plurality of peak candidates in parallel. As set out below, clusters may be identified by selecting candidate peaks having peak centers within a predetermined distance of each other or intersecting each other at greater than a predetermined amplitude. For example, a predetermined distance of a half peak-width or a predetermined amplitude of intersection of 10% of maximum amplitude are suitable.

A fine fit contribution 117 and a bumps contribution 118 is determined from the fine fit 116 and the aligned bump component 115.

Feature values 119 are determined from the processed peaks as set forth above. Each feature value is indicative of an abundance associated with a given peak. This may take the form of an amplitude or peak area. As set out in further detail below, determining the feature value entails combining the relative abundance calculated from peaks identified in the fine structure 117 with the quantitative analysis of the bump structure 118 in order to determine a more precise feature abundance.

### Exemplary Results

Deep MALDI spectra were collected on two different MALDI-TOF instruments: the Bruker RapifleX (Bruker, Billerica, MA, USA) and the SimulTOF100 (SimulTOF Systems, Marlborough, MA, USA).

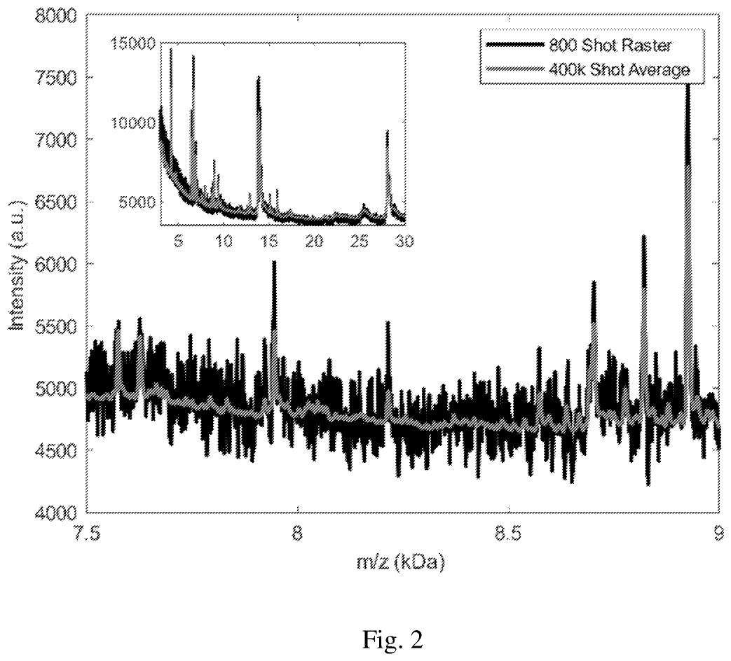

Referring to FIG. 2, example spectra are shown, collected on the RapifleX of an individual raster spectrum (black) and a 400k shot Deep MALDI averaged spectrum (grey) from 7.5 to 9 kDa m/z range. The inset shows the same spectra over the full 3 to 30 kDa range analyzed in this work.

In the Deep MALDI process, for each sample preparation, multiple 800 laser shot (“raster”) spectra are collected. Individual raster spectra have significant noise, and only the strongest peaks can be accurately resolved as shown in FIG. 2. To improve the measurement sensitivity and to decrease the noise, one averages 500 aligned raster spectra to create a single 400k shot averaged spectrum. The 400k shot Deep MALDI averaged spectrum shows a greatly improved signal-to-noise ratio (SNR) and well-defined peaks are now visible that were previously hidden within the noise of a single raster spectrum. Although the sensitivity of the Deep MALDI spectra could be improved further by averaging more individual rasters, the 400k shot averaged spectra result is a good compromise between sensitivity and instrument run time.

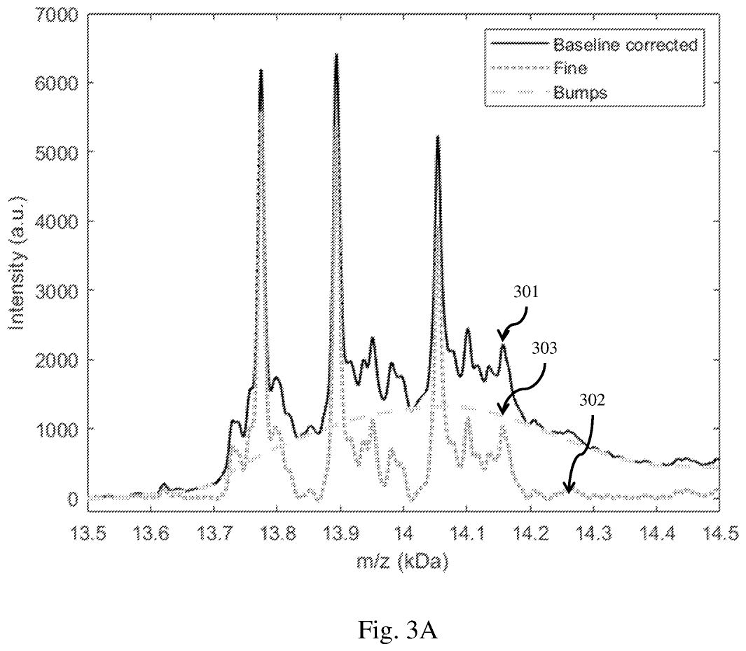

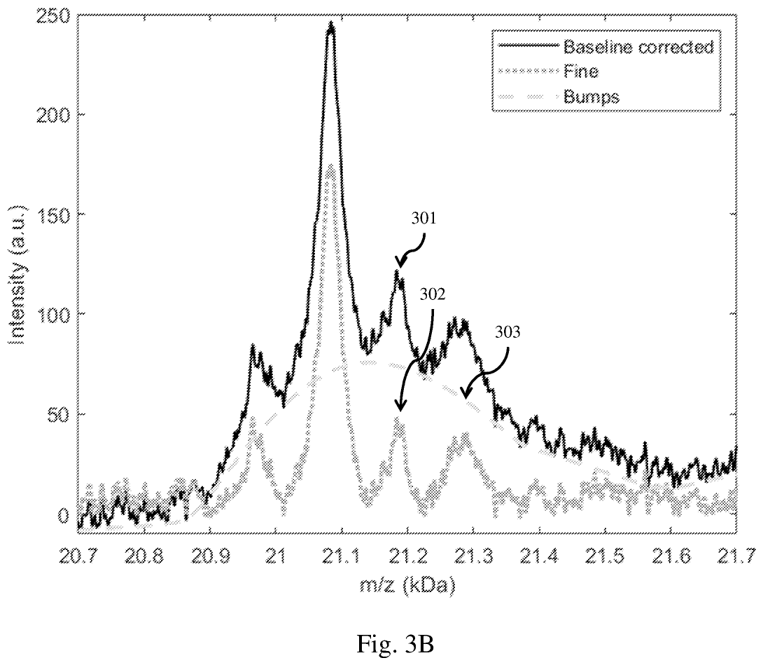

Referring to FIG. 3, a spectral component analysis shows the baseline corrected Deep MALDI spectrum (301, solid), Fine structure (302, dotted) and Bumps (303, dashed) for peak clusters. FIG. 3A provides these features around 14 kDa, while FIG. 3B shows these features around 21 kDa.

Because of the large number of proteins and peptides in serum samples, complex structure is observed in the baseline corrected spectra. A baseline corrected spectrum often contains sharp features (peaks) sitting atop broad, wide features (“bumps”) as shown in FIG. 3. The origin of the peaks is easy to understand as coming from singly charged proteins or polypeptides of a given mass. The bumps can be attributed to unresolved peaks, e.g., those arising from clusters of highly overlapping mixtures of prominent and less prominent peaks, or from multiply charged, higher mass proteins (see FIG. 3B). Due to the combinatorial effect of multiple ion types (i.e. +H⁺, +Na⁺, +NH₄⁺, etc.) in higher charge states, the overlap of the various multiply charged large polypeptide ions results in a wide, broad, and unresolved distribution. Because the bumps originate from biological content in the sample and are not purely an artifact of the measurement process, like the background, removing the bumps during the baselining process will reduce the potential information content available in a single spectrum. To address this problem, these two components of the spectrum are separated and analyzed: the peaks (or “Fine structure”) and the bumps (“Bumps”). As detailed below, better reproducibility is achieved when information from both the fine structure and the bumps is included when determining the feature values for each peak. To maintain a consistent naming convention used in the literature, the present disclosure uses the general term “feature” to refer to the peaks and “feature value” to be the semi-quantitative numerical value we calculate to represent the relative abundance of that feature (protein or peptide) within the sample.

### MALDI Peak Shape Analysis

To improve upon the accuracy of the peak detection algorithm, particularly for overlapping peaks, a convolution approach is used whereby the spectrum is convoluted with the peak shape function of the instrument. An alternative approach would be to use Gaussian functions to describe the peak shape of MALDI-TOF mass spectra, but this simpler approach is insufficient, especially at higher masses. Individual peaks that are observed in typical spectra are asymmetrically broadened, with the right-side (high-mass side) being wider than the left-side (low-mass side). This asymmetric broadening comes from a convolution of the instrument broadening and the isotope distribution, which are m/z and mass dependent, respectively. The overall peak-shape of the peaks in the spectra were empirically determined to fit well to an asymmetric Gaussian of the form

$$s ( m ) = \{ \begin{matrix}{A}_{0} {e}^{- {( m - {m}_{0} )}^{2} ln ( 2 ) / {σ}_{L}^{2}} , & m < {m}_{0} \\ {A}_{0} {e}^{- {( m - {m}_{0} )}^{2} ln ( 2 ) / {σ}_{R}^{2}} , & m \geq {m}_{0}\end{matrix} , \qquad ( 1 )$$

where A₀ is the amplitude, m₀ is the peak center, and σ_{L} and σ_{R} are the left and right half widths at half max (HWHM), respectively.

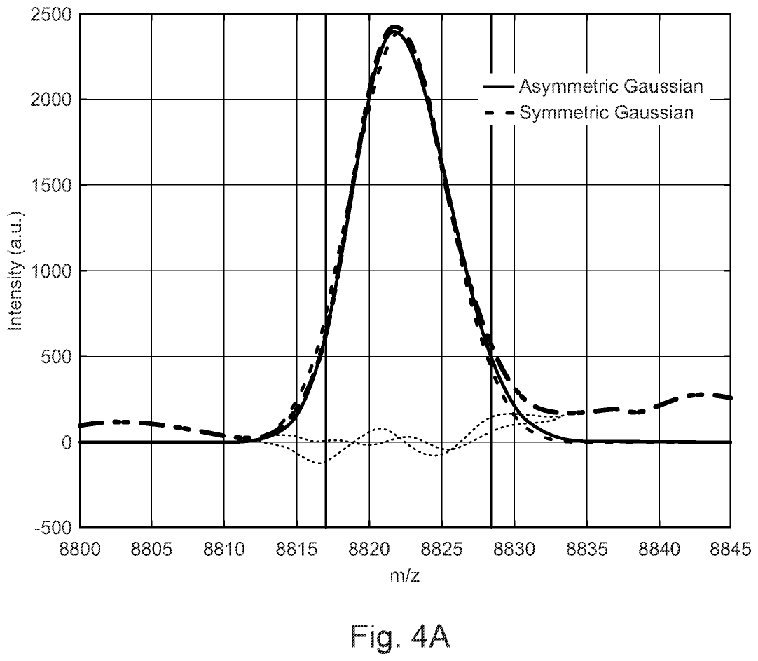

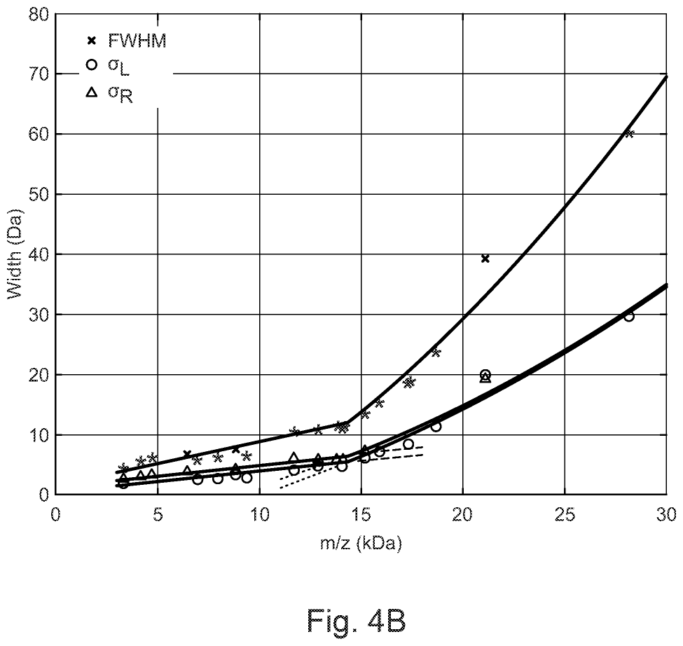

Referring to FIG. 4, peak shape determination of Bruker RapifleX MALDI-TOF spectral peaks is shown. In FIG. 4A, raw sample data (black stars) and peak fit to an asymmetric (solid) and symmetric (dashed) Gaussian are shown. Fit error is shown by the dotted lines. In FIG. 4B, peak shape parameters as a function of m/z are shown. Overall fitted trend is shown with solid lines and the linear (dashed) and quadratic (dotted) piecewise portions for σ_{L} and σ_{R} of the fits are extended past the trend range for reader visibility.

FIG. 4A shows a typical, isolated peak in a Deep MALDI averaged spectrum and the symmetric (dashed) and asymmetric (solid) Gaussian fits. Only data points with an intensity greater than 0.25 times the maximum intensity were used in the fit. The dotted lines show the calculated error between the raw data and the fitted peak. The sum of the absolute error in the fitting range is 1158.4 a.u. for the symmetric Gaussian fit and 150.6 a.u. for the asymmetric Gaussian fit. The asymmetric Gaussian fit shows a consistent improvement over the symmetric Gaussian fit across the entire m/z range of the peak.

A selection of 19 prominent and isolated peaks, selected to span the acquisition range, were fit to asymmetric Gaussians to determine the m/z dependence of the peak width. FIG. 4B shows the Full Width at Half Max (FWHM), σ_{L}, and σ_{R} as a function of the m/z range. The right-HWHM is consistently larger than the left-HWHM across the range, although at higher masses, the difference is less pronounced.

The trends of left- and right-HWHM across the m/z range were empirically found to fit well to a piecewise function of the m/z coordinate, m, as

$${σ}_{i} ( m ) = \{ \begin{matrix}{a}_{0} + {a}_{1} m , & m < {m}_{init} \\ {c}_{0} + {c}_{1} m + {c}_{2} {m}^{2} , & m \geq {m}_{init}\end{matrix} , \qquad ( 2 )$$

where mᵢₙₜ is the intersection of the linear and quadratic portions of the piecewise function. The FWHM is simply

$$FWHM ( m ) = {σ}_{L} ( m ) + {σ}_{R} ( m ) . \qquad ( 3 )$$

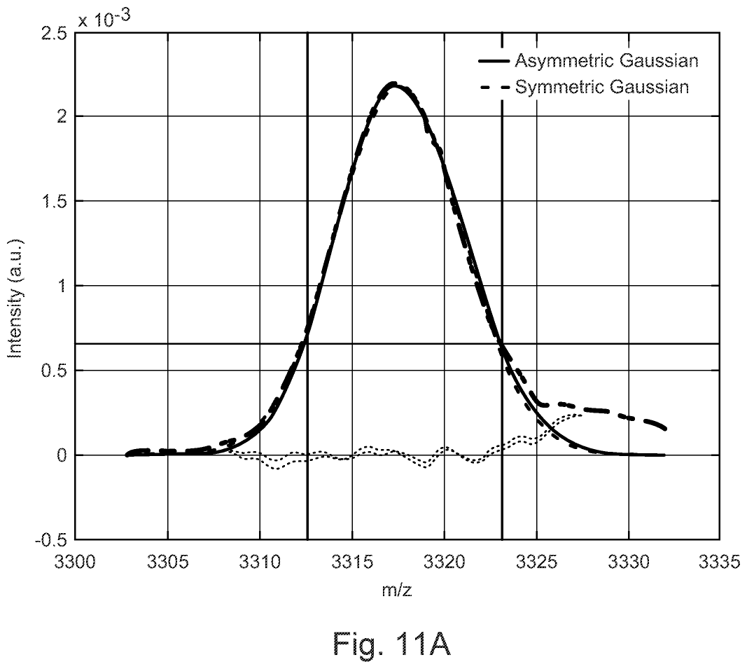

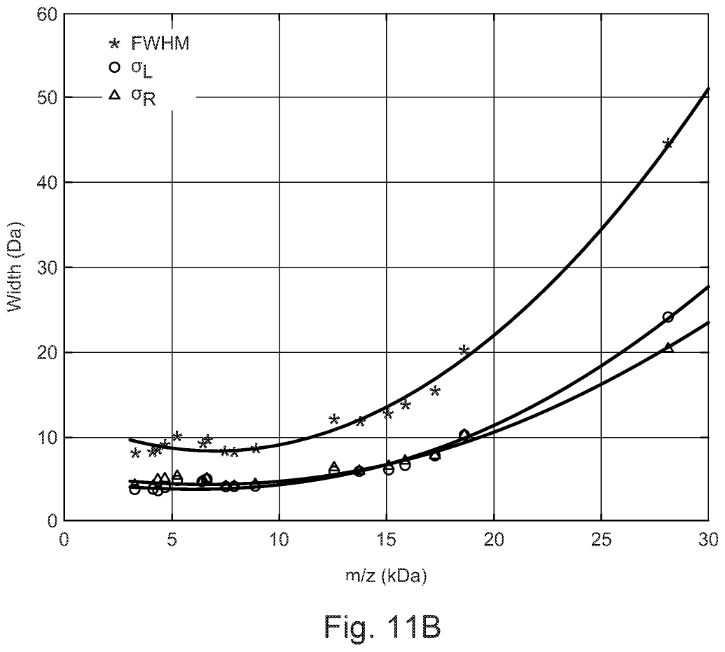

The average results of 12 different reference sample preparations were used to generate the peak width parameters for the RapifleX shown in Table 1. These parameters are stable over the course of multiple months and running hundreds of samples on the instrument, as shown in FIG. 11. The corresponding peak shape parameters for the SimulTOF100 are shown in Table S1, but it is worth noting that, due to the difference in instrumentation, the peak shape trends fitted well to a single quadratic for the SimulTOF100 and therefore mᵢₙₜ=0 in Equation 1.

TABLE 1
The average peak width parameters for the FWHM,
left-, and right-HWHM for the RapifleX.

| | a₀ | a₁ | c₀ | c₁ | c₂ | mᵢₙₜ |
|---|---|---|---|---|---|---|
| FWHM | 2.878 | 5.89E−04 | 5.764 | −1.13E−03 | 1.05E−07 | 14471 |
| σ_{L} | 1.374 | 2.55E−04 | −3.143 | −9.53E−06 | 3.99E−08 | |
| σ_{R} | 1.504 | 3.33E−04 | 8.907 | −1.12E−03 | 6.54E−08 | |

### Spectral Analysis of Deep MALDI Spectra

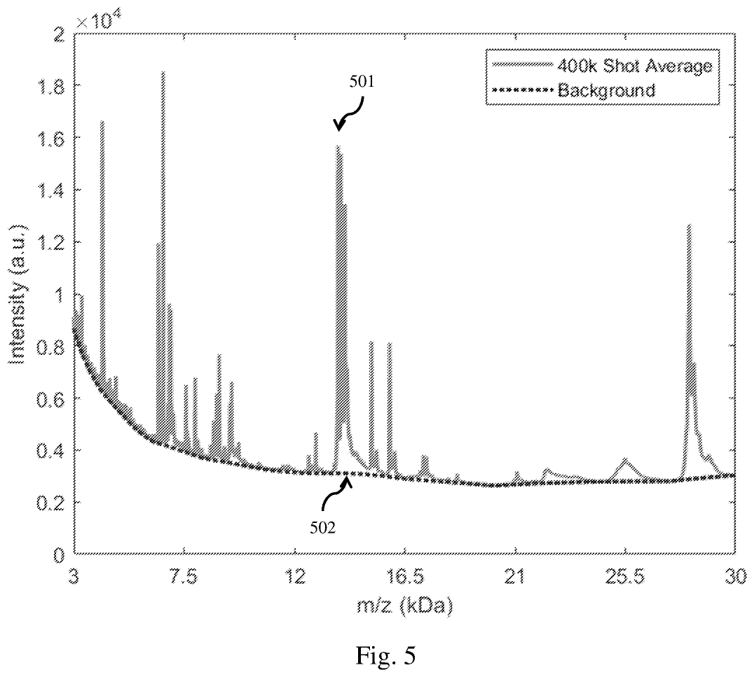

Referring to FIG. 5, an example of a 400k shot averaged Deep MALDI spectrum 501, solid collected on the RapifleX and the associated Eilers' background estimation 502, dashed is provided.

Background estimation. The 400k shot average has a pronounced background that varies across the acquisition range, as shown in FIG. 5. The background was estimated using Eilers' estimation. This method for background estimation allows for an elastic background that is penalized differently for errors above and below the background line. For the example spectra, Eilers' parameters of λ₁=10¹¹, λ₂=10⁴, and p=0.001 provided a good background estimation, (BG₁), without over-fitting to the spectral peaks.

Fine-structure determination and peak fitting. As described above, the Fine structure is defined to be only the component of the MALDI spectra that contains the sharp features on a flat background. The Fine structure was calculated by subtracting a relaxed Eilers' background (λ₁=10⁶, λ₂=10², and p=0.001) (BG₂), from the Deep MALDI spectra. The Bumps were calculated as the difference between the relaxed and stiff backgrounds:

$$Bumps ( m ) = {BG}_{2} ( m ) - {BG}_{1} ( m ) . \qquad ( 4 )$$

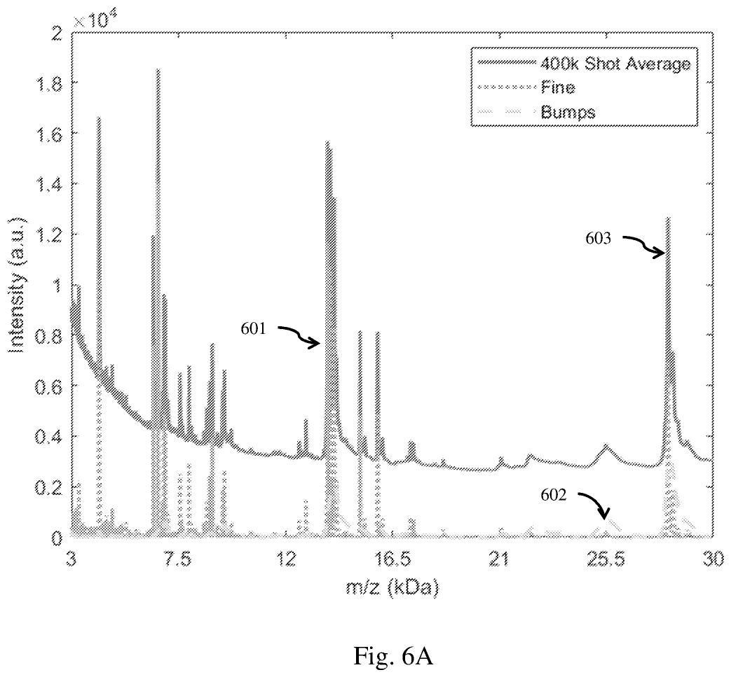

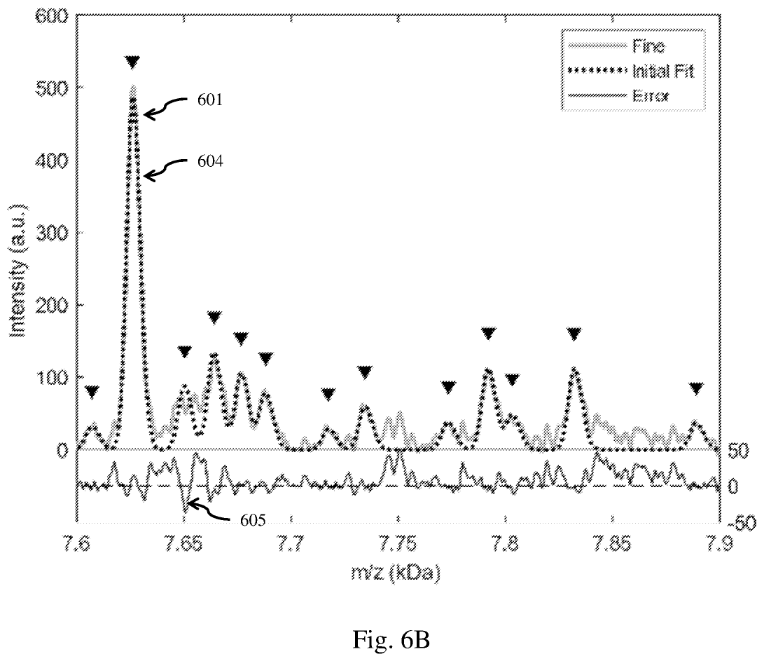

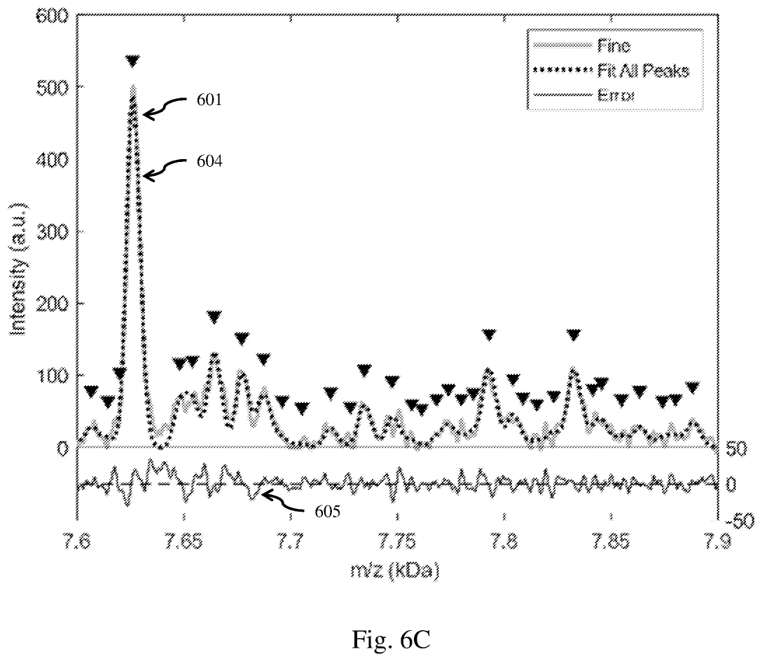

Referring to FIG. 6, a visual representation of peak fitting and feature value determination is provided. FIG. 6A shows a single processed Deep MALDI spectrum (603, solid) showing the Fine structure (601, dotted) and Bumps (602, dashed) components. FIG. 6B shows initial peak finding (604, dotted) and result of applying the fitting algorithm to the Fine structure (601, solid) of a single spectrum in the range 7.5-7.9 kDa. FIG. 6C shows the complete fitting of the same range using the master list of all peaks. The triangles indicate locations of fitted peaks and the trace 605 at the bottom shows the error in the peak fit.

A peak finding algorithm (based on the convolution of the Fine structure with the peak-shape) was used to determine the largest peaks that could be used to align spectra to a common m/z axis and to generate a master peak list from multiple samples. The master peak list is a collection of all unique peaks found across all samples and is used to accurately fit the entire spectrum, even peaks that are only sporadically detected. Briefly, the convolution of the spectrum Fine structure with the peak shape function is calculated to differentiate true peaks from artifact structures like noise. The algorithm then searched for peaks that had SNR>10 and whose centers were more than one FWHM away from adjacent peaks. FIG. 6B shows a sub-range of the entire spectrum that has the fit of the peaks found by this algorithm. Typically, between 700 and 800 peaks with SNRs in this range are found for an individual 400k shot Deep MALDI spectrum acquired from 3-30 kDa on the RapifleX. This peak list was used to align the sample to a common m/z axis to allow direct comparison across different samples.

Although the peak fitting clearly does a good job of fitting the strongest features, there are some peaks (such as near 7.75 kDa or 7.85 kDa shown in FIG. 6B) that are not fit, because they were not identified by the peak fitting algorithm with the specified parameters. Because each sample will have a different relative abundance of proteins, the intensity of individual peaks will vary across samples. This means that if a peak is not detected by the peak finding algorithm for a given sample, either because the peak is low intensity, too close to a more prominent peak, or not present in the sample, it may be detected in a different sample. It is assumed that most proteins are present across different samples albeit at very different concentrations. To determine the set of potential peaks detectable in blood-based samples, the lists of peaks from the Qualification set of 40 different samples and from the reference sample (measured with 220 unique preparations and acquisitions as described below) were merged into a master list of unique peaks, resulting in a total of 1657 peaks for the RapifleX and 1256 peaks for the SimulTOF100 instruments.

Accurate peak intensities can be calculated by fitting the pre-defined peak shape function, to each peak in the master peak list, yielding a semi-quantitative feature value for each peak (“Standard” feature value). Here, the fitted peak amplitude, A₀, is used as the Standard feature value, other choices of the feature value, such as the area under the fitted peak, could also be used. The result of the fit of all peaks is shown in FIG. 6C for the same acquisition and m/z range as was shown in FIG. 6B.

For each peak, the “Enhanced” feature value was calculated as the sum of the fitted Fine structure peak amplitude and the intensity of the Bumps spectrum at the same m/z location.

### Reproducibility

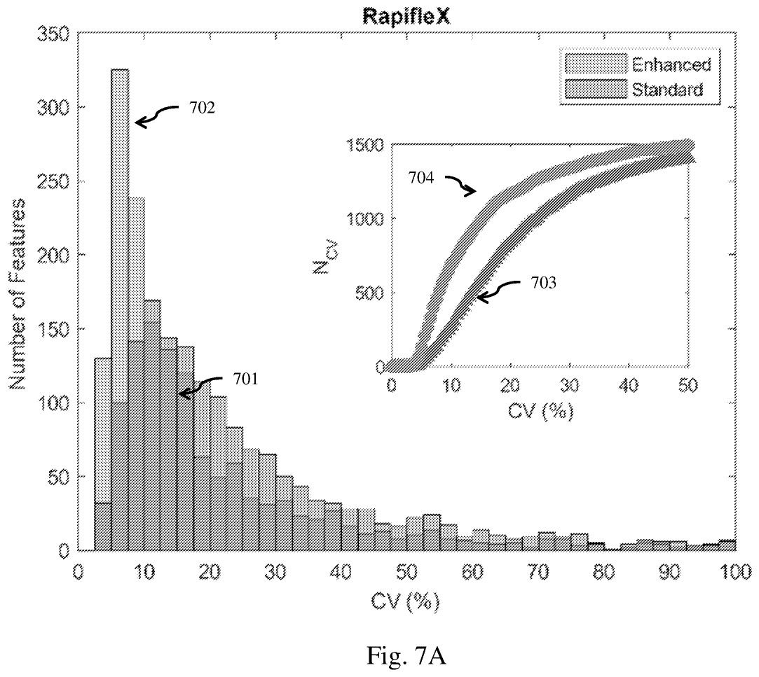

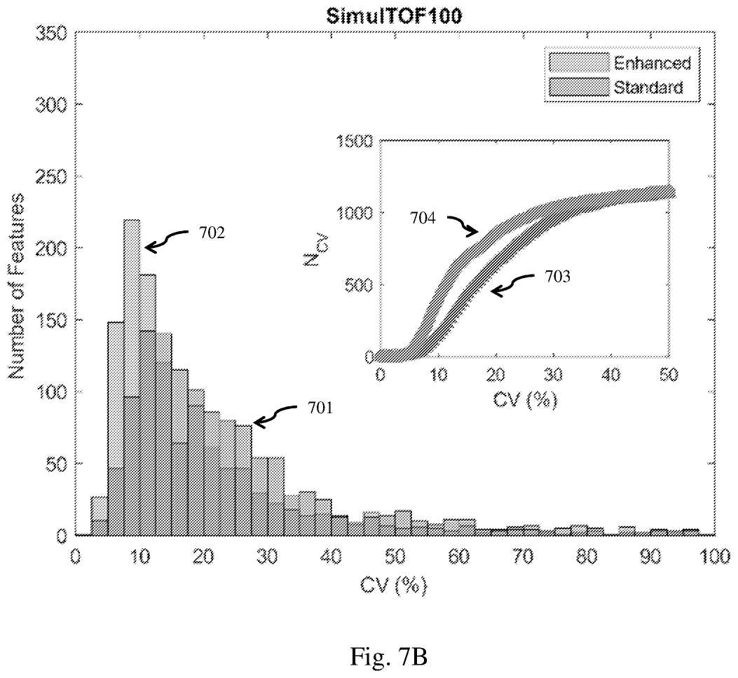

Referring to FIG. 7, reproducibility of feature values for a single sample over 20 preparations and acquisitions is illustrated. The data of FIG. 7A were collected on the RapifleX and the data of FIG. 7B were collected on the SimulTOF100. Histograms of CVs for Standard (701) and Enhanced (702) feature values are shown in the main plot. The inset shows the cumulative CV distribution, N_{CV}, for the Standard (703, triangles) and Enhanced feature values (704, circles) (only CVs up to 50% are shown for clarity).

To determine the reproducibility of the spectral processing and the resulting feature values, Deep MALDI spectra obtained from 20 replicate preparations of the reference sample were processed and the variations in the calculated feature values were compared. The coefficient of variation (CV) was measured for each feature using the Standard feature values of the fitted peaks, as shown in FIG. 7 (701, 703). The reproducibility can be further improved by including the information in the Bumps. The CV distribution for the Enhanced feature values for all peaks in the master peak list is shown in lighter grey in FIG. 7.

The improvement in reproducibility is further shown by the traces in the insets of FIG. 7, which show the cumulative CV distribution, N_{CV}, for the two methods of analysis, where

$${N}_{CV} ( x ) = P ( CV \leq x ) , \qquad ( 5 )$$

and P(CV≤x) is the probability that the CV is less than or equal to x. The Enhanced feature value trace shows substantially more features with lower CVs than the Standard features for the entire range. For example, for the RapifleX spectra, using Enhanced feature values there are 1000 feature with CV<15.26%, while using Standard feature values there are only 594 features. In the following analysis the feature values calculated using the Enhanced approach are considered.

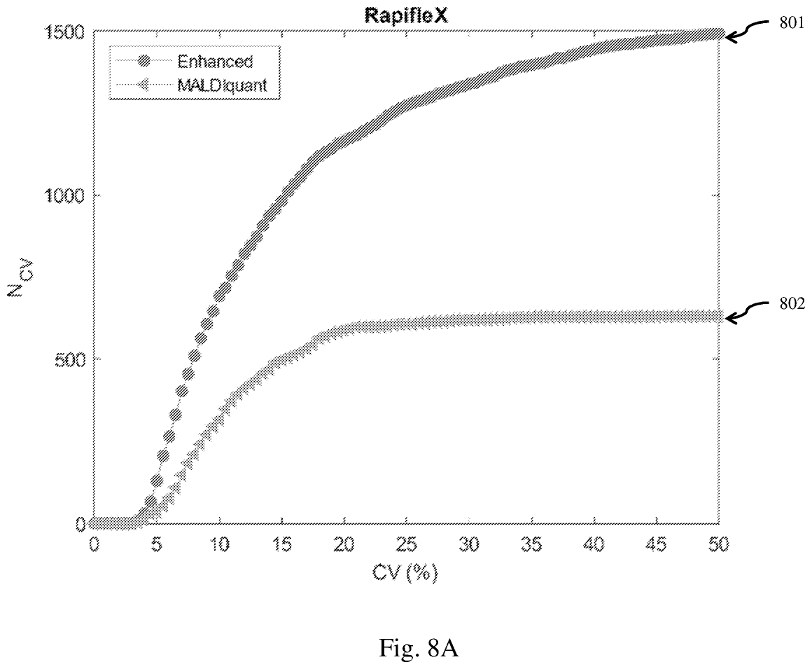

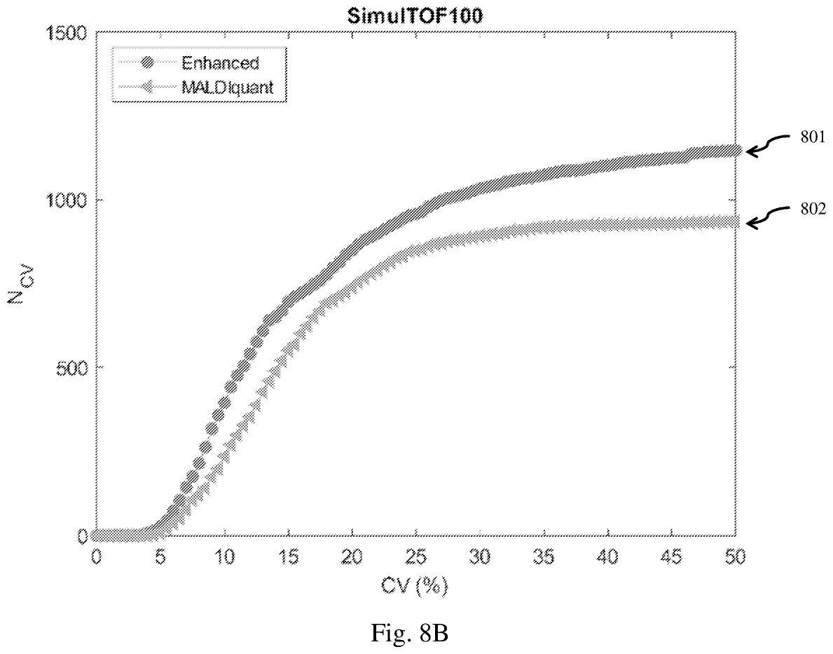

To compare the reproducibility of processing according to the present disclosure to that of a commonly used software package, Deep MALDI spectra were analysed using the MALDIquant software package. To maintain consistency with the method of creating a master peak list, the built-in functionality of MALDIquant was used to bin peaks over the identical 220 spectrum set to generate its own master peak list. The total number of peaks to fit was determined using the Median Absolute Deviation (MAD) method with a SNR cutoff of 2. A low SNR was chosen to select as many features as possible. Due to slight variations in peak positions not being numerically identical, the peaks were binned with a 0.002 Da tolerance, which resulted in 635 features for the RapifleX acquisition and 947 features for the SimulTOF100. CVs were calculated for the 20 replicate measurements of the reference sample and the comparison with the results from our processing methods is shown in FIG. 8.

Referring to FIG. 8, a comparison of reproducibility of the present approach with a published method, MALDIquant, is provided. MALDIquant is described further in Gibb, et al., MALDIquant: A Versatile R Package for the Analysis of Mass Spectrometry Data. Bioinformatics 2012, 28, 2270-2271, doi:10.1093/bioinformatics/bts447. Cumulative CV distribution, N_{CV}, for the same Deep MALDI spectra analyzed with the presented methods using Enhanced feature values (801, circles) and with MALDIquant processing (802, triangles) are given for RapifleX in FIG. 8A and for SimulTOF100 in FIG. 8B. Only CVs up to 50% are shown for clarity.

Association with Biological Processes

It is important that the features represented here not only present reproducible data, but also are also biologically relevant. The association of each feature with 23 biological processes was computed using protein set enrichment analysis (PSEA). This bioinformatics tool determines the association between a measured quantity, in this case a mass spectral feature, and a biological process by assessing the correlation between the measured quantity and the abundances of a set of known proteins related to the biological process. Table 2 shows the total number of features that were determined to be associated with each biological process with p-value of association <0.01 and a false discovery rate (FDR) of <5%.

Table 2. Number of features associated with each biological process with FDR of <5% and a p-value of association <0.01 for 400k-shot spectra collected on the RapifleX and SimulTOF100 mass spectrometers using the processing and feature definitions presented in this paper. A comparison is made with the number of associated features obtained with the same 400k-shot spectra collected on the SimulTOF100 mass spectrometer using an alternative processing and feature definition method described in Tsypin, et al., Extending the Information Content of the MALDI Analysis of Biological Fluids via Multi-Million Shot Analysis. PLOS ONE 2019, 14, e0226012, doi:10.1371/journal.pone.0226012. The percentages show the proportion of all analyzed features that show an association with the biological process. Note the substantial increase in the number of associated features identified when the new processing feature definition method is used.

| | Associated Features | | |
|---|---|---|---|
| | | | Tsypin, |
| Biological Process | RapifleX | SimulTOF | et al. |
| Acute phase response | 655 (43.2%) | 460 (40.6%) | 122 (40.9%) |
| Complement activation | 619 (40.8%) | 383 (33.7%) | 70 (23.5%) |
| Acute inflammatory | 434 (28.6%) | 317 (27.9%) | 109 (36.6%) |
| response | | | |
| IFN γ signaling/response | 266 (17.5%) | 147 (12.9%) | 25 (8.4%) |
| Immune tolerance | 227 (15.0%) | 189 (16.6%) | 31 (10.4%) |
| and suppression | | | |
| Wound healing | 202 (13.3%) | 160 (14.1%) | 100 (33.6%) |
| IFN type 1 | 195 (12.9%) | 82 (7.2%) | 33 (11.1%) |
| signaling/response | | | |
| Type 17 immune response | 73 (4.8%) | 82 (7.2%) | 2 (0.7%) |
| Angiogenesis | 54 (3.6%) | 28 (2.5%) | 2 (0.7%) |
| Response to hypoxia | 42 (2.8%) | 54 (4.7%) | 7 (2.3%) |
| Cellular component | 27 (1.8%) | 6 (0.5%) | 4 (1.3%) |
| morphogenesis | | | |
| Cytokine production | 21 (1.4%) | 31 (2.7%) | 3 (1.0%) |
| involved in | | | |
| immune response | | | |
| Glycolysis | 21 (1.4%) | 36 (3.2%) | 2 (0.7%) |
| Chronic inflammatory | 19 (1.3%) | 23 (2.0%) | 2 (0.7%) |
| response | | | |
| Innate immune response | 18 (1.2%) | 30 (2.6%) | 8 (2.7%) |
| Extracellular matrix | 16 (1.1%) | 4 (0.4%) | 0 (0.0%) |
| organization | | | |
| Behavior | 7 (0.5%) | 2 (0.2%) | 8 (2.7%) |
| Epithelial-mesenchymal | 6 (0.4%) | 4 (0.4%) | 0 (0.0%) |
| transition | | | |
| NK cell mediated immunity | 4 (0.3%) | 11 (1.0%) | N/A |
| T-cell mediated immunity | 4 (0.3%) | 5 (0.4%) | N/A |
| Type 2 immune response | 2 (0.1%) | 11 (1.0%) | N/A |
| B-cell mediated immunity | 2 (0.1%) | 6 (0.5%) | N/A |
| Type 1 immune response | 1 (0.1%) | 1 (0.1%) | N/A |

The goal of the processing methods set out herein is to better characterize complex MALDI-TOF spectra by improving peak detection and quantification. Because common peak detection approaches often perform poorly for clustered peaks, the method of spectral convolution is used to select peaks. Quantitation of peak intensity is also difficult to accurately determine when the peak of interest is part of a clusters of peaks. One cannot simply take the maximum intensity at the peak location because the tails of adjacent, overlapping peaks will add to the overall intensity at that location. Due to this complication, alternative approaches would define the entire cluster as a single feature that spanned a spectral range instead of decomposing the cluster into individual peaks. By accurately fitting the clusters, each individual peak intensity can be accurately determined without the influence of adjacent peaks. By implementing these ideas and utilizing the often-neglected information in the component of the spectra that varies more slowly with m/z (the Bumps), more peaks can be detected with improved reproducibility than alternative processing methods. The improved characterization can also lead to a better understanding of the direct biological implications of different features in our spectra.

### MALDI Peak Shape Analysis

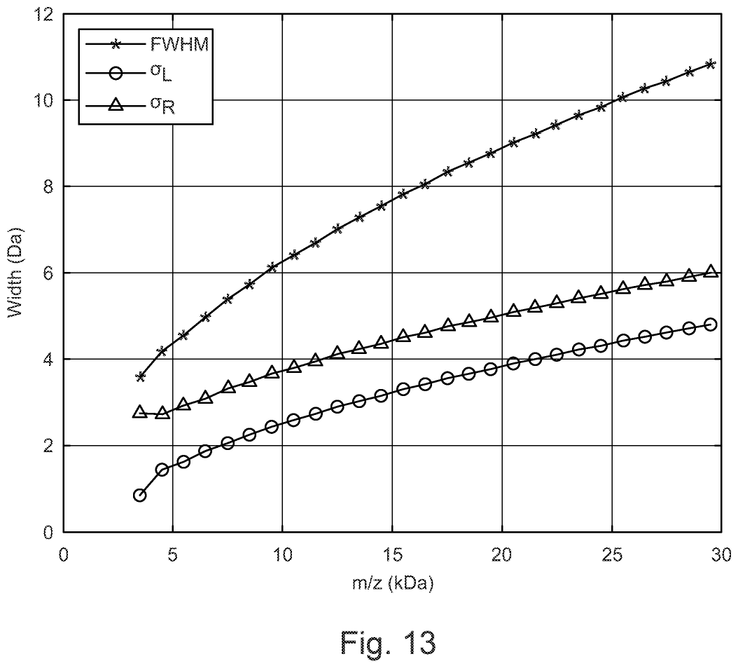

The m/z dependence on the peak shape is due to inherent protein properties (isotopic distribution) and instrument response function (IRF). For any individual protein, the peak shape that is observed in a spectrum is a convolution of the isotopic distribution of the protein with the instrument response function. As proteins get larger, a wider isotopic distribution is expected. An estimation of the peak width change with mass is shown in FIG. 13, based on proteins composed of the fictional amino acid Averagine. Similarly, the mass spectrometer is known to have a variable IRF over wide mass ranges that results in wider features further from the optimal (tuned) mass range. The change in trend from linear to quadratic shown in FIG. 4B is likely due to a change in the IRF.

The IRF is a difficult parameter to determine directly, so for this work an empirical fit is used. If the IRF could be carefully measured, it would be possible to get higher-resolution spectra by deconvoluting the observed spectra with the IRF and the isotope distribution. Such information could be useful in better determining component parts of the bumps or perhaps eliminate the bumps altogether.

### Peak Detection and Feature Value Determination

Alternative fitting methods may rely on simply removing the broad structures (Bumps) during background subtraction, resulting in only sharp features (Fine structure). These broad features originate from real biological content that is unresolved (see FIG. 3) and thus potentially valuable information is lost when the bumps are overlooked during background estimation and subtraction. During the spectral analysis presented here, an individual spectrum is decomposed into three separate components: the background, the Fine structure, and the Bumps. By maintaining a slowly varying background, the bumps spectrum can be extracted, which was shown to improve quantitative reproducibility.

The methods provided herein show improved quantification of highly reproducible features, at the expense of being computationally slower (˜3 minutes/spectrum) than the MALDIquant software (several seconds/spectrum). This is in part due to the high-level MATLAB language in this example, which could be sped up with a faster language, but it is also due to the differences in the peak detection algorithms. In the present work, peak detection is enhanced by convoluting the spectrum with the asymmetric peak shape that is defined for each instrument. Although this is a computationally intensive task, the convolution sharpens features and effectively filters the noise, which allows for more accurate detection of low intensity peaks. The MAD peak detection algorithm that is used in the MALDIquant analysis simply finds local maxima and only selects those that are above the SNR cutoff. Because of the convolution, for the RapifleX data, a total of 1657 peaks were identifiable while using a SNR cutoff of 10, while the MAD method used in the MALDIquant processing only found 635 features with a SNR of 2.

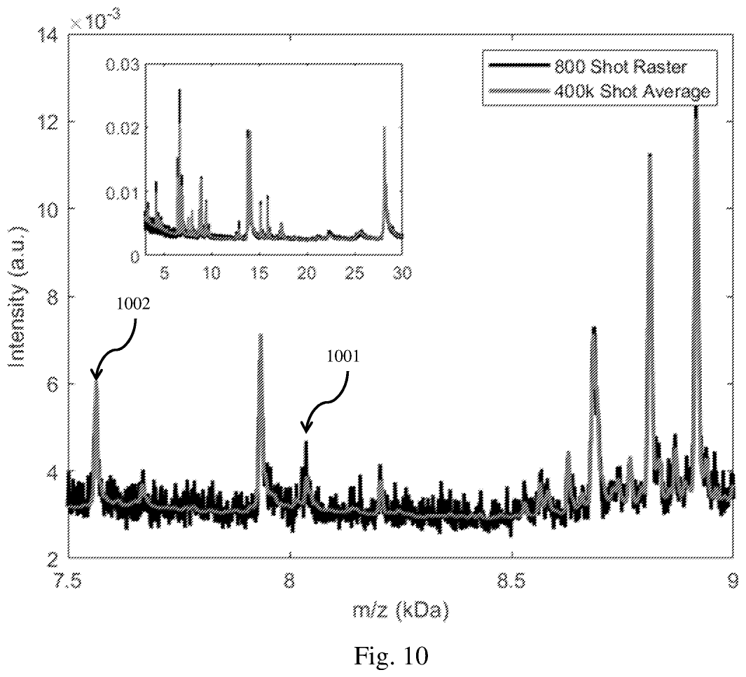

To further evaluate these algorithms, an additional 220 sample preparations were processed on another mass spectrometer (SimulTOF100). The spectra acquired on the SimulTOF100 were processed using the presented methods, and 1256 unique features were found (see FIG. 10 and Table S1 for peak shape analysis on the SimulTOF100). The Deep MALDI spectra collected on the SimulTOF100 were also analyzed using MALDIquant, which found 947 features. Although the MALDIquant processing appeared to do better with spectra from this instrument, the processing methods provided herein still produce a greater number of highly reproducible features.

### Reproducibility

The methods provided herein show an improvement over current traditional processing techniques as tested by the MALDIquant software package. For both sample sets run on the RapifleX and SimulTOF100 instruments, a greater number of features (with Enhanced feature values) with smaller CVs are defined and characterized with the presented processing than with MALDIquant software package.

Due to the large number of highly reproducible features, diagnostic tests can be created to stratify and classify patients into different groups to predict patient outcome based on this processing method.

### PSEA

Gene set enrichment analysis (GSEA) is a tool in bioinformatics that associates a measured quantity (for example, gene expression) with a biological process by finding patterns of association across a set of genes known to be related to that process. Using a similar approach, Deep MALDI features can be associated with biological processes in a protein set enrichment analysis.

In Deep MALDI, there is an improvement of the number of features associated with biological processes with increasing number of laser shots. The direct comparison (same number of laser-shots generated the Deep MALDI spectra and the same p-value cutoff and FDR were used) to this baseline is shown in Table 2. The methods and procedures presented here show a substantial increase in the number of associated features in nearly all the biological processes investigated.

### Exemplary Materials and Methods

### Serum Samples

A total of 40 serum samples (“Qualification set”) that were derived from the blood of lung cancer and colorectal cancer patients were purchased from Discovery Life Sciences, Inc (Huntsville, AL, USA). A reference sample was created by pooling equal volumes of serum obtained from ten healthy individuals, also purchased from Discovery Life Sciences, Inc. The 100 serum samples collected from patients with non-small cell lung cancer used for association with biological processes via protein set enrichment analysis (“PSEA set”) were purchased from Oncology Metrics, LLC (Fort Worth, TX, USA) and Discovery Life Sciences Inc (Huntsville, AL, USA). All samples were collected under ethics-approved protocols according to the requirements of Discovery Life Sciences Inc and Oncology Metrics LLC and were stored at −80° C.

### Sample Preparation

Serum samples were thawed and 3 μL aliquots of each sample were spotted onto a serum card (GE HealthCare, Chicago, IL, USA). The spots were allowed to dry for 1 hour at ambient temperature after which the whole serum spot was punched out from the underside with a 6 mm skin biopsy punch (Acuderm, Fort Lauderdale, FL, USA). Each punch was placed in a centrifugal filter with 0.45 μm nylon membrane (VWR, Randor, PA, USA). In cases where the serum spots had spread outside the 6 mm diameter, the section where serum was visible was excised and added to the tube containing the 6 mm punch. To the centrifugal filter containing the punch, 100 μL of HPLC grade water (JT Baker, Randor, Pa, USA) was added. The punches were vortexed gently for 10 minutes then spun down at 14,000 rcf for two minutes. The flow-through was removed and transferred back on to the punch for a second round of extraction consisting of vortexing gently for three minutes and spinning down at 14,000 rcf for two minutes. Finally, 20 μL of the filtrate from each sample was then transferred to a 0.5 mL Eppendorf tube. All subsequent sample preparation steps were carried out in a custom designed humidity and temperature control chamber (Coy Laboratory, Grass Lake, MI, USA). The temperature was set to 30° C. and the relative humidity at 10%.

An equal volume of freshly prepared matrix (25 mg of sinapinic acid per 1 mL of 50% acetonitrile: 50% water plus 0.1% TFA) was added to each 20 μL serum extract and the mix vortexed for 30 sec. The first three aliquots (3×2 μL, for SimulTOF100) or five aliquots (5×2 μL, for Rapiflex) of sample: matrix mix were discarded into the tube cap. Eight aliquots of 2 μL sample: matrix mix were then spotted onto a stainless steel MALDI target plate (Bruker, Billerica, MA, USA and SimulTOF Systems, Marlborough, MA, USA for spectra acquisition on the RapifleX and SimulTOF 100, respectively). The MALDI plate was allowed to dry in the chamber before placement in the MALDI mass spectrometer.

For the work on generating a master peak list and reproducibility a total of five replicate batches of the Qualification set (40 serum samples) were analyzed for each mass spectrometer. Each batch consisted of the 40 serum samples with an additional four preparations of reference sample used as controls, with two preparations spotted at the start and two at the end of the batch. This resulted in a total of 220 spectra per mass spectrometer (5×40 samples in the Qualification set and 20× of the reference sample).

Samples for the PSEA set were run in batches of up to 44 samples with an additional four preparations of the reference sample used as controls, with two preparations spotted at the start and two at the end of the batch for each mass spectrometer.

Mass Spectra acquisition

RapifleX. MALDI spectra were obtained using a RapifleX MALDI-TOF mass spectrometer (Bruker, Billerica, MA, USA). The instrument was operated in positive ion mode, with ions generated using a frequency tripled, Nd: YAG laser emitting at 355 nm and laser repetition rate of 5 kHz. Spectra were acquired in the 3 kDa to 30 kDa m/z range with a sampling rate of 0.63 Gs/s. External calibration was performed using the following peaks in the spectra generated from the reference samples included on every target plate (or batch): m/z=3320, 4158.7338, 6636.7971, 9429.302, 13890.4398, 15877.5801 and 28093.951. From each spot, 100 raster spectra were collected, totaling 800 raster spectra per sample. A raster spectrum is an average over 800 laser shots measured across a single spot.

SimulTOF100. MALDI spectra obtained using a SimulTOF100 MALDI-TOF mass spectrometer (SimulTOF Systems, Marlborough, MA, USA). The instrument was operated in positive ion mode with ions generated using a 349 nm, diode-pumped, frequency-tripled Nd: YLF laser operated at a laser repetition rate of 0.5 kHz. Raster spectra were acquired in the 3 to 75 kDa m/z range (only the range from 3 to 30 kDa was used in this analysis) and were ‘hardware averaged’ to contain 800 laser shots as the laser fires continuously across the spot while the stage is moving at a speed of 0.25 mm/s. External calibration was performed using the following peaks generated in the reference sample included on every target plate: m/z=3320, 4158.7338, 6636.7971, 9429.302, 13890.4398, 15877.5801 and 28093.951.

### Spectral Analysis

The spectral analysis workflow is shown in FIG. 1 for processing of raw data through generation of a feature table or matrix (a list of feature values for each feature for each sample). Post-processing, such as normalization or corrections can be performed on the table of feature values.

The following insets provide pseudocode Peak detection of a single sample (Algorithm 1), calculation of a feature table for a sample (Algorithm 2), and determining a master peak list (Algorithm 3).

Algorithm 1 Peak detection of a single sample

| | |
|---|---|
| 1: | Acquire Deep MALDI ® spectrum, (I_{DM}) |
| 2: | procedure BASELINE CORRECTION (I [symbol] ) |
| 3: | Estimate background of I_{DM} with Eilers [symbol] estimation, I_{BG1}(λ₁ = 10¹¹, λ₂ = 10⁴, p = 0.001) |
| 4: | I [symbol] (m/z) = I_{DM}(m/z) − I_{BG1} |
| 5: | end procedure |
| 6: | procedure DETERMINE BUMPS AND FINE STRUCTURE(I_{Bumps}, I_{Fine}) |
| 7: | Calculate aggressive Ellers [symbol] estimation, I_{BG2}(λ₁ = 10⁶, λ₂ = 10², p = 0.001) |
| 8: | I_{Bumps} = I_{BG2} − I_{BG1} |
| 9: | I_{Fine} = I_{DM} − I_{BG2} |
| 10: | procedure FINE SUB-RANGES OF M/Z RANGE TO FIT({Chuck₁, ... , Chunkₙ}) |
| 11: | $Z = \{ \frac{\text{?}}{\text{?}} = 0 \}$ |
| 12: | Chunkᵢ = \|Zᵢ, Zᵢ₊₁) |
| 13: | end procedure |
| 14: | end procedure |
| 12: | Chunkᵢ = \|Zᵢ, Zᵢ₊₁) |
| 15: | $procedure DETECT PEAKS ( {P}_{ampl} = \{ {P}_{j}^{( fit )} \} )$ |
| 16: | Pₐₘₚₗ = { } |
| 17: | for Chunkᵢ ∈ {Chunk₁, ... , Chunkₙ} do |
| 18: | procedure CONVOLUTE WITH PEAKSHAPE(I [symbol] ) |
| 19: | Find m/z midpoint (m_{mid}) of Chunkᵢ |
| 20: | Determine peakshape function at midpoint, (f_{PS}(m_{mid})) |
| 21: | I [symbol] = I_{Fine} * f_{PS}(m_{mid}) |
| 22: | end procedure |
| 23: | $procedure FIND PEAKS CANDIDATES ( {P}_{j}^{( cand )} )$ |
| 24: | Estimate noise, N = \|I_{Fine} − Gaussian smoothed(I_{Fine})\| |
| 25: | SNR = I_{Fine}/N |
| 26: | $Find local maxima of I \text{?} and set all as potential peak candidates ( \{ {P}_{k}^{( cand )} \} )$ |
| 27: | end procedure |
| 28: | $procedure FIT PEAK CANDIDATES FOR EXACT PEAK LOCATIONS ( {P}_{j}^{( fit )} )$ |
| 29: | $for {P}_{j}^{( cand )} ∈ \{ {P}_{k}^{( cand )} \} do$ |
| 30: | $if SNRj \geq 10 and {P}_{j}^{( cand )} not influenced by {P}_{j + 1}^{( cand )} then$ |
| 31: | ${P}_{j}^{( fit )} = the fit of {f}_{PS} ( {P}_{j}^{( cand )} ) to {I}_{Fine} on range ( {P}_{j}^{( cand )} - Δ m , {P}_{j}^{( cand )} + Δ m )$ |
| 32: | ${P}_{ampl} = {P}_{j}^{( fit )} ⋃ {P}_{ampl}$ |
| 33: | $else if {SNR}_{j} \geq 10 and {P}_{j}^{( cand )} is influenced by {P}_{j + 1}^{( cand )} then$ |
| 34: | $Add {P}_{j}^{( cand )} to cluster {C}_{i} containing all influencing peaks$ |
| 35: | else if SNRᵢ < 10 then |
| 36: | $Discard {P}_{i}^{( cand )}$ |
| 37: | end if |
| 38: | end for |
| 39: | for Each cluster, Cⱼ do |
| 40: | N = number of peaks in Cⱼ |
| 41: | $\{ {P}_{k}^{( fit )} , … , {P}_{k + N - 1}^{( fit )} \} = the simultaneous fit of N asymmetric Gaussians {f}_{PS} ( {P}_{k}^{( cand )} )$ |
| | to I_{Fine} spanning the range of Cⱼ |
| 42: | ${P}_{ampl} = \{ {P}_{k}^{( fit )} , … , {P}_{k + N - 1}^{( fit )} \} ⋃ {P}_{ampl}$ |
| 43: | end for |
| 44: | end procedure |
| 45: | end for |
| 46: | end procedure |

[symbol]

indicates data missing or illegible when filed

Algorithm 2 Calculate Feature Table for Sample

| | |
|---|---|
| 1: | Calculate Pₐₘₚₗ as outlined in Algorithm 1 |
| 2: | procedure ALIGN SPECTRA (I_{Fine,Align}) |
| 3: | $Set {P}_{ampl}^{80 th} , such that {P}_{ampl}^{80 th} is the 80 th percentile of SNR of {P}_{ampl}$ |
| 4: | Split Pₐₘₚₗ into alignment ranges R = {(m₁, m₂), [m₂, m₃), ... , [mₙ₋₁, mₙ)} |
| 5: | for Rᵢ do |
| 6: | $Fit {P}_{ampl}^{80 th} to alignment points using quadratic fit$ |
| 7: | Adjust m/z for range Rᵢ based on fit to create I_{Fine,Align} and I_{Bumps,Align} |
| 8: | end for |
| 9: | end procedure |
| 10: | procedure CALCULATE FEATURE VALUES(FV) |
| 11: | for Pᵢ ∈ master peak list (PLₘₐₛₜₑᵣ) do |
| 12: | if Pᵢ is not part of a cluster then |
| 13: | $Fit amplitude of {f}_{PS} ( {P}_{i} ) to {I}_{Fine , Align} to get {FV}_{i}^{Fine}$ |
| 14: | else if Pᵢ is part of a cluster of {Pᵢ, ... , Pⱼ} then |
| 15: | $Simultaneously fit amplitudes of \{ {f}_{PS} ( {P}_{k} ) \} to {I}_{Fine , Align} to get {FV}_{i}^{Fine} , … , {FV}_{j}^{Fine}$ |
| 16: | end if |
| 17: | ${FV}_{i} = {FV}_{i}^{Fine} + {I}_{Bumps , Align} ( {P}_{i} )$ |
| 18: | end for |
| 19: | end procedure |

Algorithmn 3 Determine Master Pask List

| | |
|---|---|
| 1: | procedure DETERMINE THE INDIVIDUAL PEAKS FOR A SET OF SAMPLES({P [symbol] P [symbol] }) |
| 2: | for Each sample i in the set do |
| 3: | Calculate P [symbol] as outlined in Algorithm 1 |
| 4: | Align P [symbol] as outlined in Algorithm 2, steps 1-9 |
| 5: | end for |
| 6: | end procedure |
| 7: | procedure CREATE THE MASTER PEAK LIST(PLₘₐₛₜₑᵣ) |
| 8: | Set PLₘₐₛₜₑᵣ = { } |
| 9: | for P [symbol] ∈ {P [symbol] P [symbol] } do |
| 10: | PLₘₐₛₜₑᵣ = P [symbol] ∪ PLₘₐₛₜₑᵣ |
| 11: | Update clusters in PLₘₐₛₜₑᵣ as needed based on new peaks from P [symbol] |
| 12: | end for |
| 13: | end procedure |

[symbol]

indicates data missing or illegible when filed

Raster Averaging for Deep MALDI Spectra. To increase the number of observable peaks and to improve the SNR in the MALDI-TOF spectra, the Deep MALDI raster averaging technique was employed. Briefly, each raster spectrum of 800 shots was processed through an alignment workflow to align peaks to a set of internal alignment points (Tables S2, S3). Peaks were detected in each raster spectrum with a SNR cut-off>3.0. The identified peaks for a raster spectrum were then used together with the set of predefined alignment peak positions to establish the coefficients in a second order polynomial (in m/z) that was used to transform the m/z values of this raster spectrum. For successful alignment, a minimum of 20 detected peaks was required, with at least 13 peaks useable for alignment, i.e., have an un-aligned peak position within a fixed alignment tolerance (1500 ppm) of the alignment peak. A maximum shift of 15 Da was allowed at the lowest m/z alignment point.

Averages were created from the pool of aligned raster spectra that satisfied the alignment quality criteria. A random selection of 500 raster spectra, without replacement, were averaged to create a final analysis spectrum of 400,000 shots for each sample.

Background Estimation. The spectrum background was calculated using a stiff Eilers' estimation (λ₁=10¹¹, λ₂=10⁴, p=0.001). Briefly, the Eilers' estimation is an asymmetric least squares fitting that penalizes positive and negative deviations separately, allowing for accurate estimation of the background.

Fine Structure and Bumps Determination. The stiff background does not overfit the spectra and subtraction from the spectra results in sharp features that still are sitting on top of broad features, as seen in FIGS. 3 and 5. Both the bumps and the sharp peaks may contain useful information as to total protein content in the sample but need to be treated separately to ensure accurate estimation of feature values.

A second, relaxed background with Eilers' parameters λ₁=10⁶, λ₂=10², and p=0.001 was calculated to fit the wide broad features atop the stiff background. The difference between the spectrum and the relaxed background results in the Fine structure, which contains the information of the sharp peaks on a flat background. The Bumps were defined as the difference between the relaxed background and the stiff background.

Peak Detection. Peak candidates to be fit were estimated using a peak finding algorithm based on the convolution of the Fine structure with the peak-shape. Peak candidate locations were estimated using the MATLAB function islocalmin on the second derivative of the Fine structure, with a prominence window equal to the width of the FWHM of a peak and a minimum separation of peaks equal to ¼ of the peak FWHM at the m/z location. These candidates were only fit as peaks if the SNR was greater than 10 and if the candidate was not being influenced by adjacent peak candidates. The signal was simply the intensity of the signal at the m/z point, while the noise was measured as the deviation in the signal from the average as estimated by a Gaussian-smoothing window the size of the peak-width.

A given peak was determined to be influenced by an adjacent peak if the peak centers were within half a peak-width of each other or if either peak intersected the other at greater than 10% of the maximum amplitude. Peak candidates with SNR>10 and not found to be influenced by an adjacent peak were fit to a single asymmetric Gaussian to get precise peak position and amplitude. Peak candidates with SNR>10 but which were determined to be influenced by adjacent peak candidates, were assigned to be part of a cluster. The multiplicity of a cluster, N, is defined as the number of peak candidates that are influenced by at least one other member of the cluster. Clusters were fit simultaneously by N asymmetric Gaussians (i.e., a doublet would be fit to N=2 asymmetric Gaussians and a triplet would be fit to N=3 asymmetric Gaussians, etc.). This method of fitting allows for accurate determination of the m/z position as well as peak intensity of all N peaks in the cluster. Peaks with a SNR<10 were not considered for alignment purposes or merging into the master list.

A list of all peak locations for each sample was saved to later be merged into a master list of all measurable peaks from a wide range of multiple samples.

Spectral Alignment. Spectra were aligned to a common m/z axis to ensure accurate feature (peak) intensities across samples. Alignment was done by minimizing the variation in peak positions (m/z value from the peak fitting) for the sample with respect to pre-specified alignment points (Tables S4, S5). The m/z axis was rescaled using a second order polynomial in m/z. Only peaks in the 80th percentile of SNR were used for alignment and were weighted inversely to their location in m/z, to account for the greater weights a simple linear regression gives to instances at higher m/z. A peak was determined to be alignable if its spectral position was within half of a peak width (as defined at the m/z position) of the nearest alignment point. To account for variations over the large range in m/z, we split the alignment range into 4 sub-ranges as shown in Table S6.

To ensure high-quality data, only fits with at least 5 alignable features in each region were used. Spectra that failed to align were not used in further determination.

Feature Value Determination. The fine structure was fit to 1657 (1256) asymmetric Gaussians at the specified m/z positions to extract the peak intensity for the RapifleX (SimulTOF100). Isolated peaks were simply fit to a single asymmetric Gaussian, while peaks that were part of a cluster were simultaneously fit to N asymmetric Gaussians, where N is the multiplicity of the cluster. By fitting the entire cluster simultaneously, accurate peak amplitude measurements were ensured for peaks with significant overlap. Only the intensity of each peak was fit here, while keeping the m/z position and width parameters fixed (unlike above where the m/z position is also fit). Because the spectra were aligned in the previous step, it was unnecessary to fit the m/z position and all features could be fit, even those whose SNR was under 10. This results in the ability to accurately fit peaks whose intensity ranges over 3.8 orders of magnitude. A preliminary “Standard” feature value, characterizing the magnitude of a peak was defined as the fitted peak amplitude. The preliminary feature value was further modified by adding the bump intensity at the m/z location to determine the “Enhanced” feature value. Mathematically,

$${FV}_{E} ( m ) = {FV}_{S} ( m ) + Bumps ( m ) , \qquad ( 6 )$$

where m is the m/z location, FVᵢ(m) for i=S,E is the feature value for “Standard” or “Enhanced” methods, respectively, and Bumps (m) is defined above in Equation 3.

MALDIquant analysis. The same set of 220 Deep MALDI spectra (as described for the Qualification set above) that were used to determine the master peak list were analyzed using the MALDIquant mass spectra analysis software as a methods comparison. Deep MALDI spectra were transformed using the square root transformation method to minimize any variance from the mean. Spectra were then smoothed with the Savitzky-Golay-Filter (halfWindowSize=10) and the baseline was corrected with the Statistics-sensitive Non-linear Iterative Peak-clipping (SNIP) algorithm (iterations=100). Spectra were total ion current (TIC) normalized and spectra were aligned using the “lowess” warping method (halfWindowSize=20, SNR=2, and tolerance=0.002). Peaks were determined using the MAD method (halfWindowSize=20, SNR=20) and similar peaks were binned with a tolerance of 0.002. Feature values and CVs were calculated using the 635 unique peaks determined by this method for RapifleX Deep MALDI spectra and 947 unique peaks for the SimulTOF100 Deep MALDI spectra.

### Peak Shape Fitting

A total of 19 isolated peaks were fit to asymmetric gaussians (Equation 1). The peaks were selected as isolated peaks that spanned the m/z range (3 to 30 kDa). Only the top 75% intensity was fit for peak width determination. The trends of the left- and right-HWHM were then fit to a linear trend in the low mass region (3 to 17 kDa) and a quadratic fit for the high-mass region (13 to 30 kDa) as described by Equation 2. The linear and quadratic fits were intentionally made to overlap to accurately determine the intersection of the two curves (mᵢₙₜ). The average peak shape trend parameters came from the average of 12 different preparations of the same reference serum sample measured over three batches.

To ensure there were no discontinuities while fitting the entire spectra the final mᵢₙₜ for FWHM, σ_{L}, and σ_{R} were calculated solely from the FWHM trend.

### Merge Peak Lists

A total of 220 peak lists determined in Section 4.3.4 were generated for five batches of the Qualification set as described above. All the peaks were merged into a single list resulting in 1657 unique peaks for the RapifleX and 1256 unique peaks for the SimulTOF100 (Tables S7, S8). The merged peak list was created by iteratively comparing the merged peak list (initially empty) with an un-merged list. Peaks from the un-merged list that had a peak center greater than 0.5× peak width away from adjacent peak centers in the merge list were added. Peaks with centers less than 0.5× peak width away from adjacent peaks in the merge list had their location averaged with the existing merge peak.

### Reproducibility Analysis

A total of 20 replicate measurements, including sample preparation and spectra acquisition, of the reference sample were collected over 5 batches. Spectra were processed as described above and Standard and Enhanced feature values were calculated for each replicate. Feature values were normalized to the total feature value intensity for the sample. For each feature, average feature value (x̅), standard deviation (σₓ), and coefficient of variation (CV=σₓ/x̅) were calculated.

Association with Biological Processes

The association of the identified mass spectral features with 23 biological processes was determined using protein set enrichment analysis. The biological processes investigated included both those expected to be assessable in circulation of patients with cancer (e.g., acute phase response, acute inflammatory response, wound healing) and some processes designed as controls (behavior, cellular components of morphogenesis). Briefly, protein abundance for 1305 known proteins was obtained for the PSEA set of 100 serum samples using the aptamer-based 1.3k SOMAscan assay (SomaLogic, Boulder, CO). The subsets of the 1305 proteins known to be associated with each of the 23 biological processes were identified using database searches. Deep MALDI spectra were acquired from the PSEA set using both the RapifleX and the SimulTOF100 mass spectrometers. The spectra were processed and feature values for each sample defined as described above. The Spearman correlation was calculated between each feature and each of the 1305 proteins across the 100 different samples. An enrichment score was generated for each of the 23 biological processes for each mass spectral feature with 25 splits of the sample set to provide increased power to detect association with biological processes compared with the standard GSEA enrichment score. The p-values of association between each feature and the biological processes were computed by comparing the enrichment score to a null distribution generated by a random permutation of feature values across the sample set. Features with a p-value of association <0.01 and a false discovery rate of 5% or less, as estimated by the method of Benjamini-Hochberg for multiple comparisons across the 23 biological processes, were determined to be associated with a given biological process. A subset of 1516 features were used from the Rapiflex processing and 1138 features for the SimulTOF100. These reduced feature sets were determined by removing features that are known to depend strongly on sample collection and processing details, for example features that are related to hemoglobin and its multiply charged analogs or to fibrinogen, whose spectral intensity often vary.

It will be apparent from the above discussion that the present disclosure provides a novel method for analyzing MALDI-TOF spectra over a wide spectral range. This method is used to analyze spectra from multiple samples to find 1657 unique peaks with over 3.5 orders of magnitude intensity, compared to only 635 for the alternative processing methods. The use of a well-defined peak shape function for the instrumentation allows accurate detection of a greater number of peaks, particularly among overlapping peaks. The use of peak shape also allows for accurate fitting of overlapping peaks for accurate peak amplitude measurements. When compared to a traditional processing method, a substantial increase is achieved in the number of highly reproducible features with low CVs. This processing is further validated by performing the same analysis on spectra collected on a mass spectrometer from a different manufacturer and showing improved detection and reproducibility. A set of 100 samples was analyzed with known protein variation to determine the number of features associated with biological processes. An increase was found in the number of features associated with biological processes compared to analysis of the same sample set with a different spectral processing method.

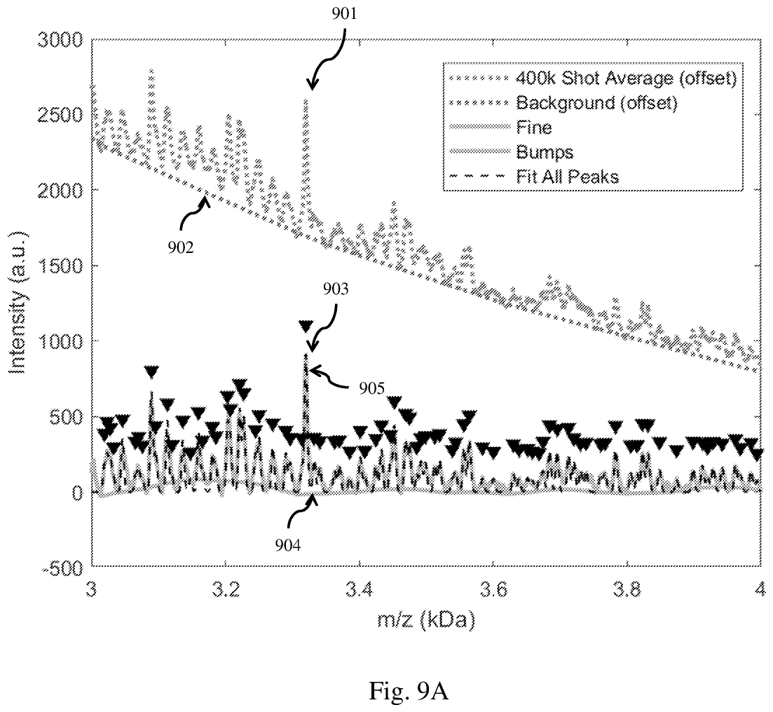

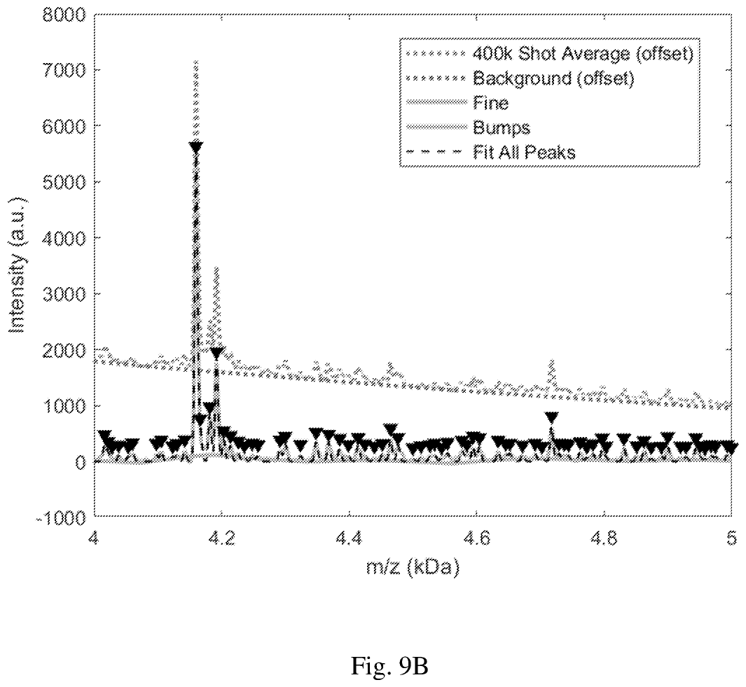

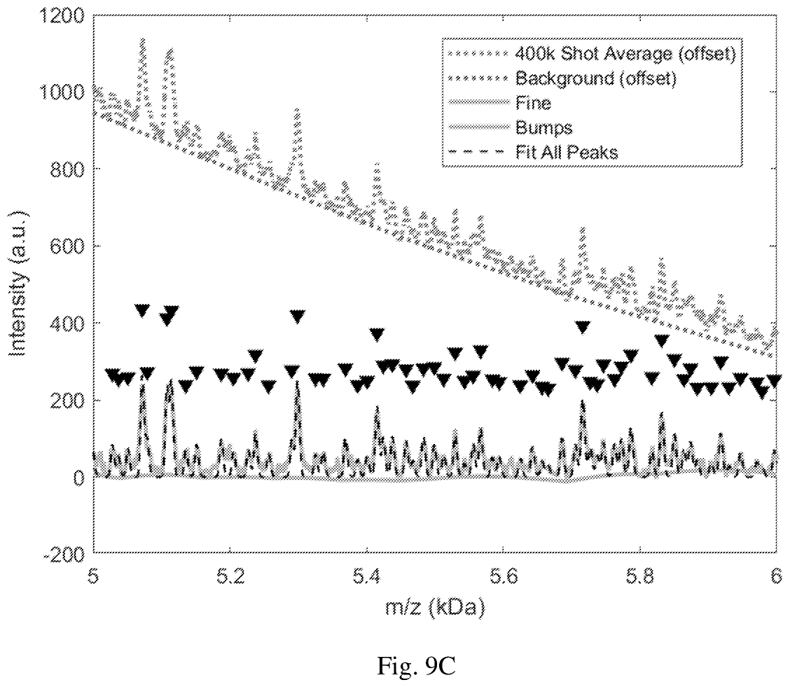

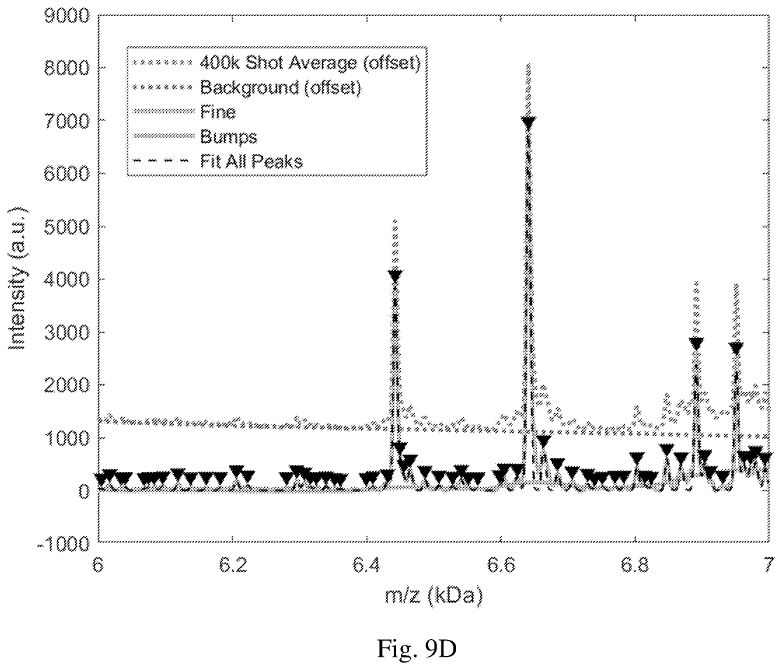

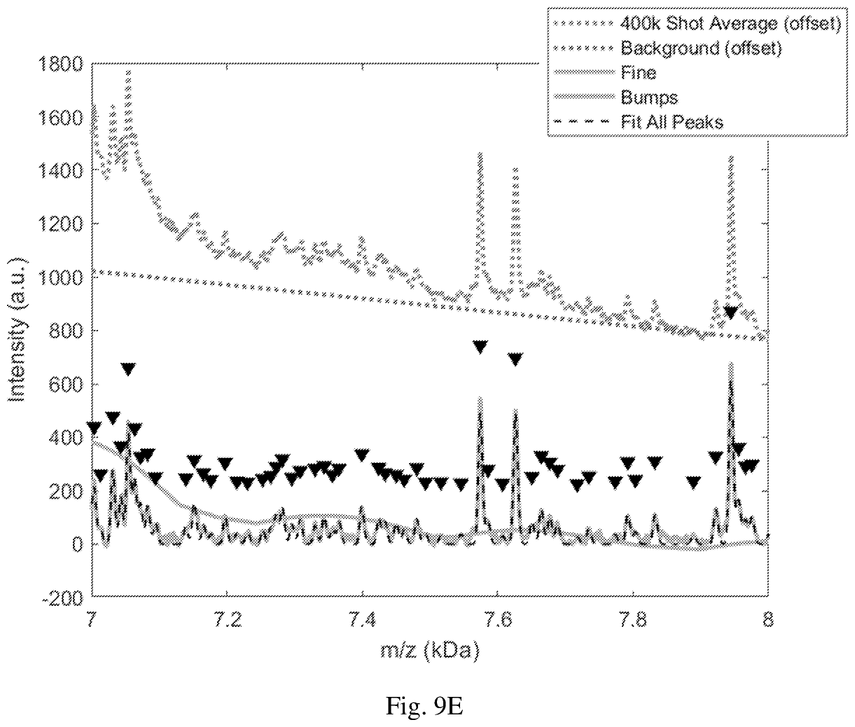

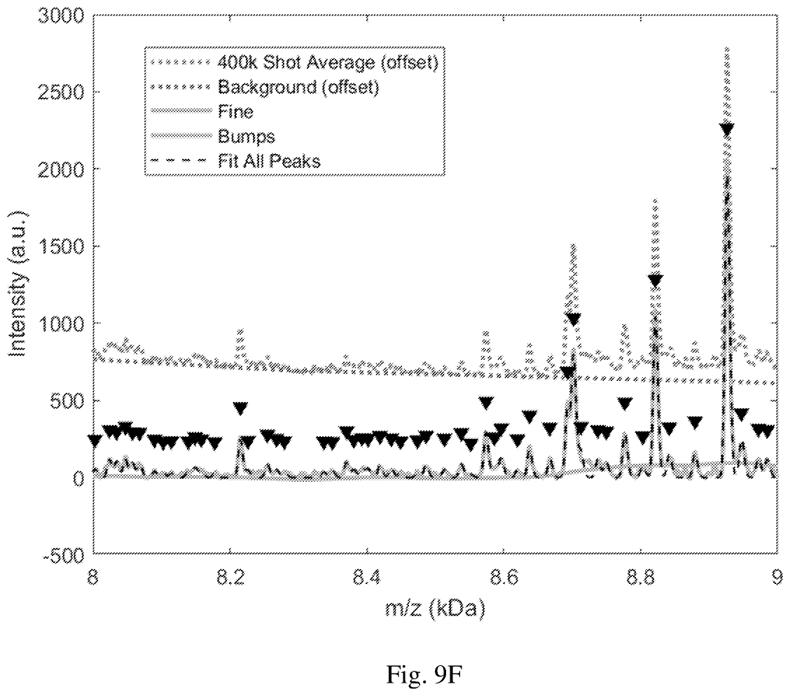

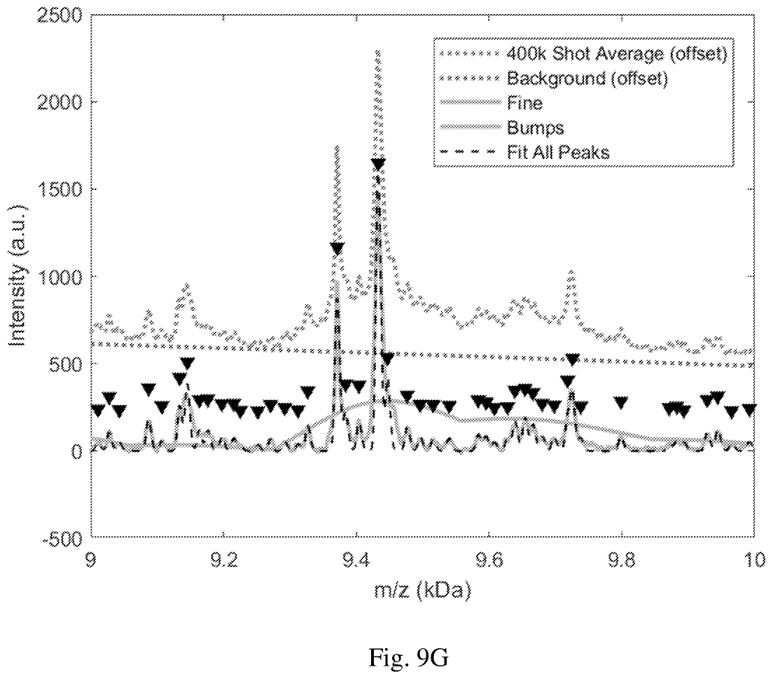

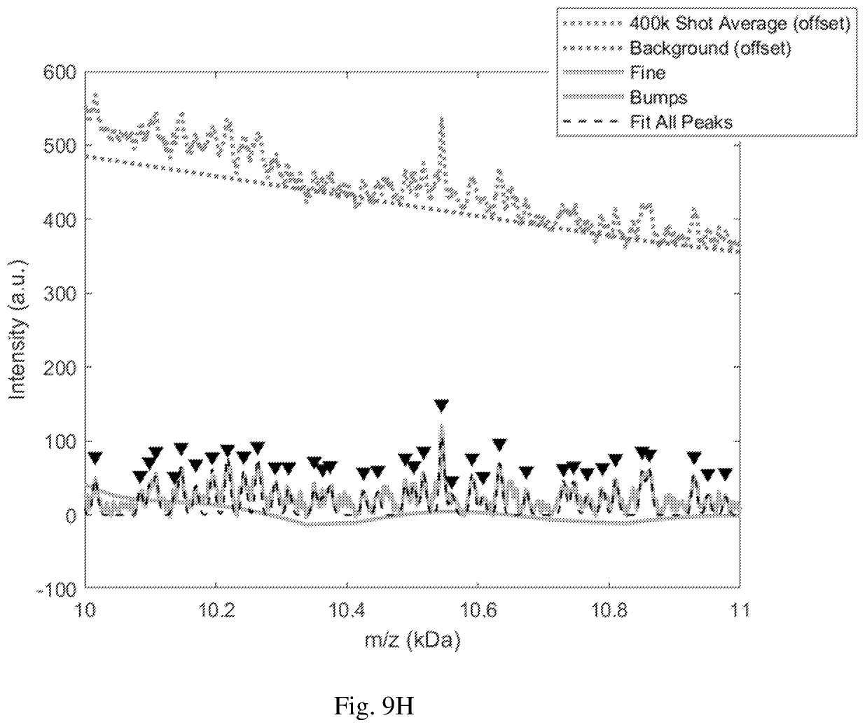

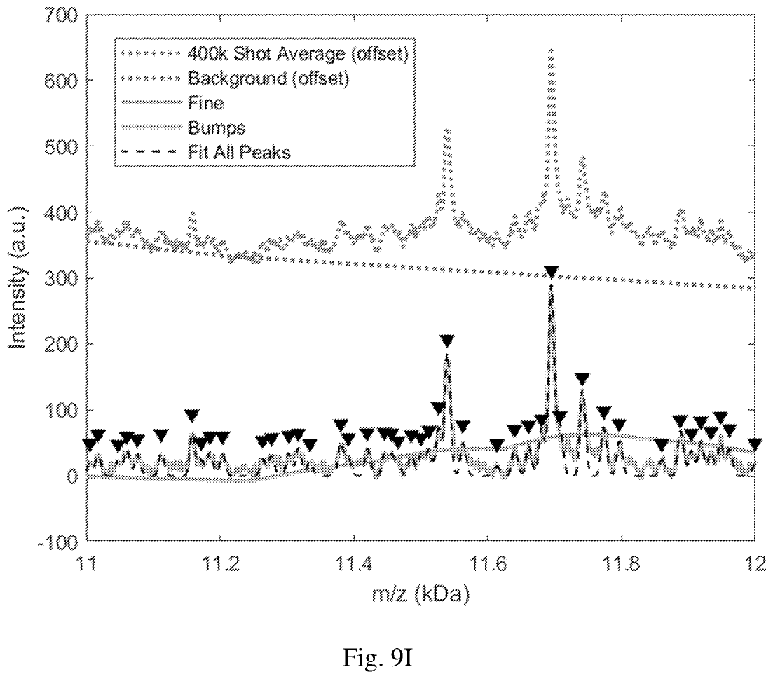

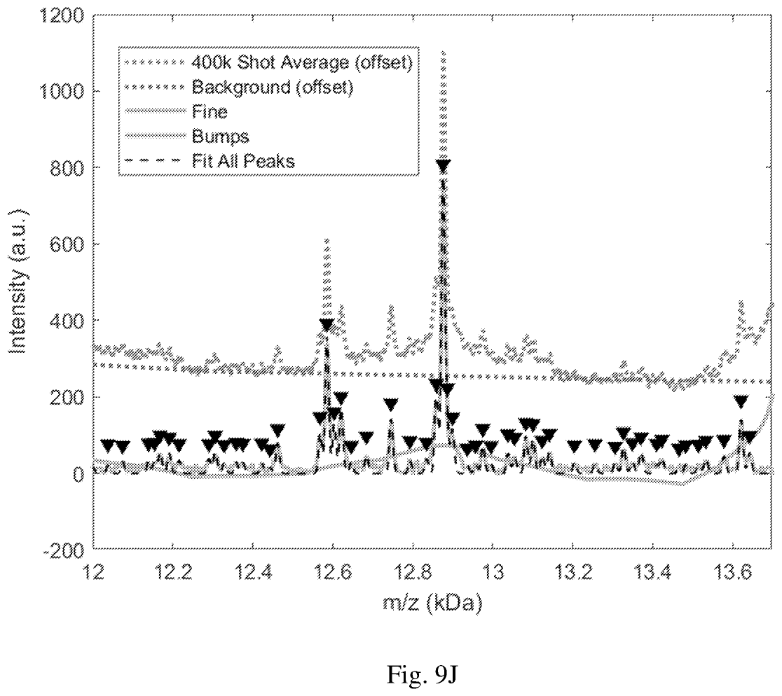

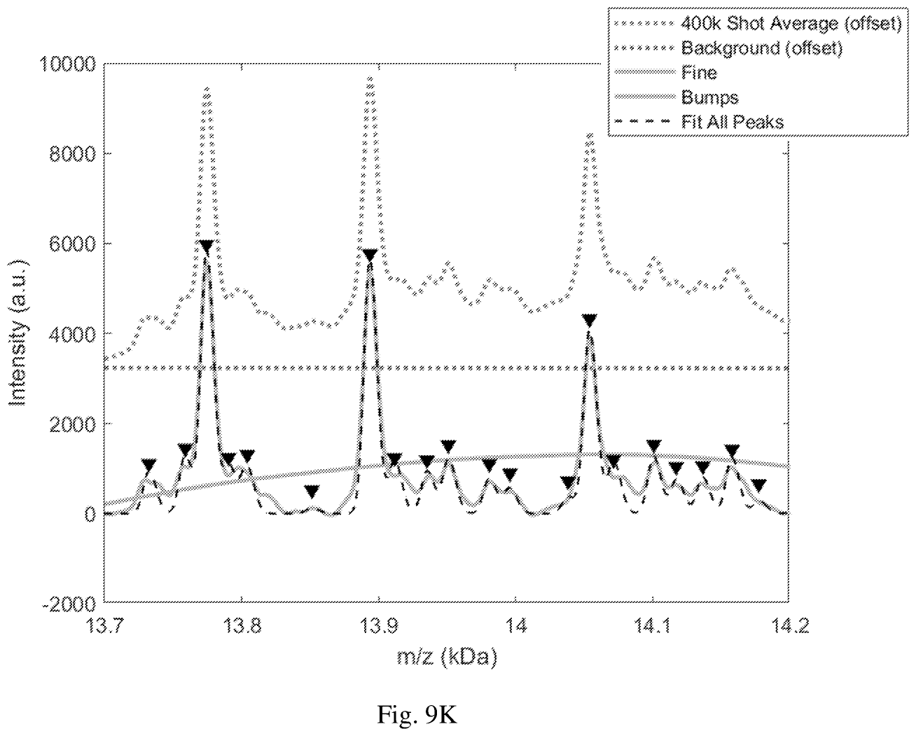

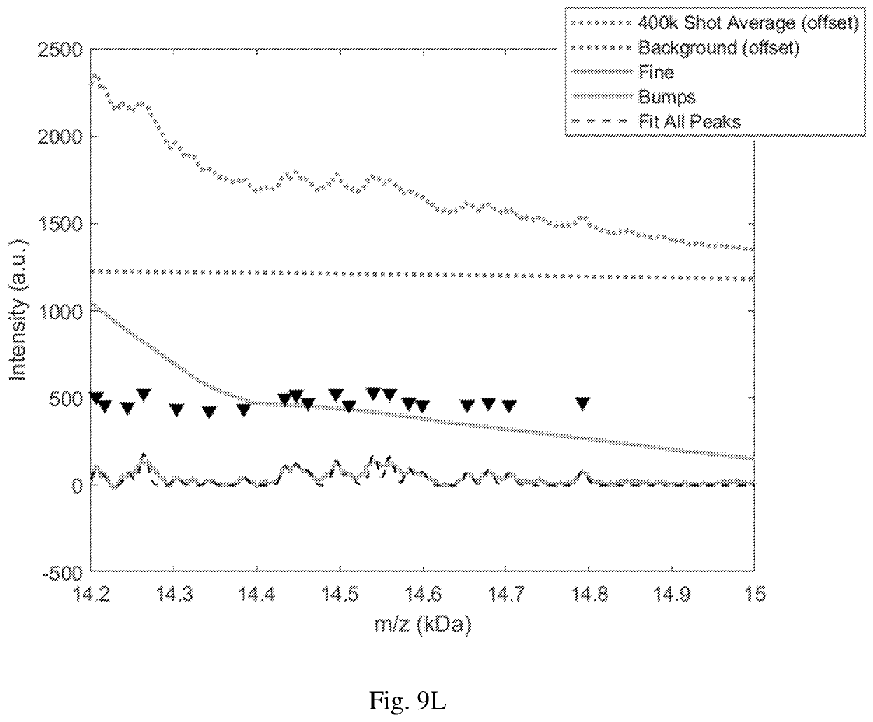

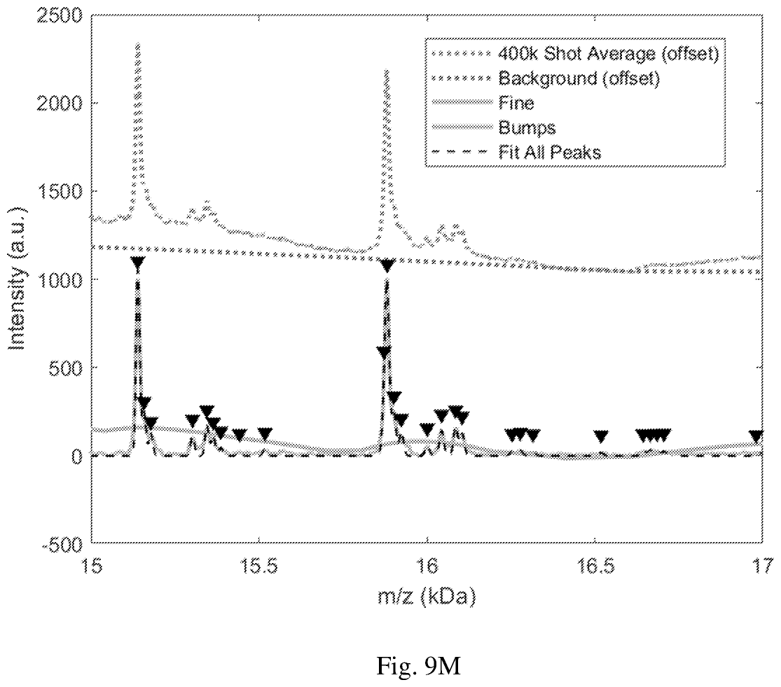

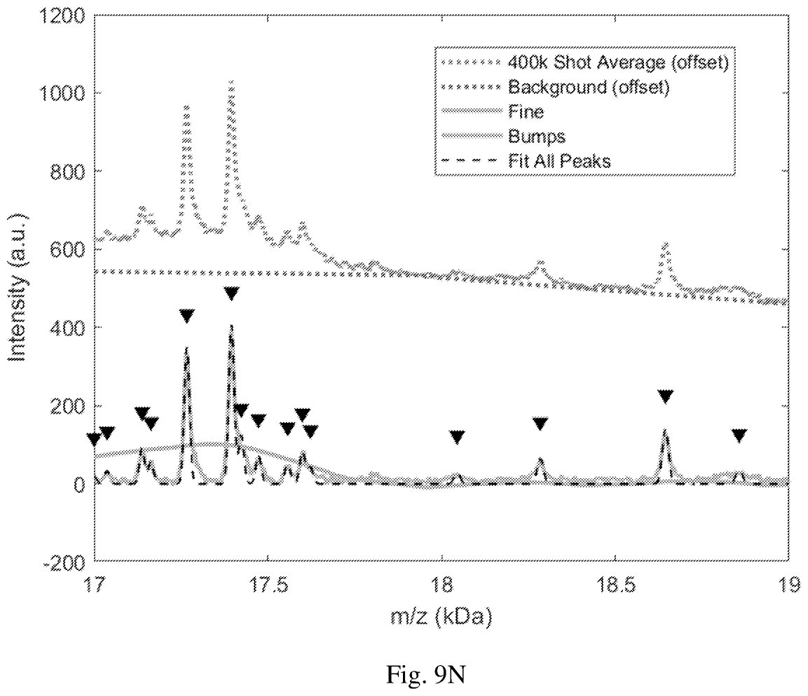

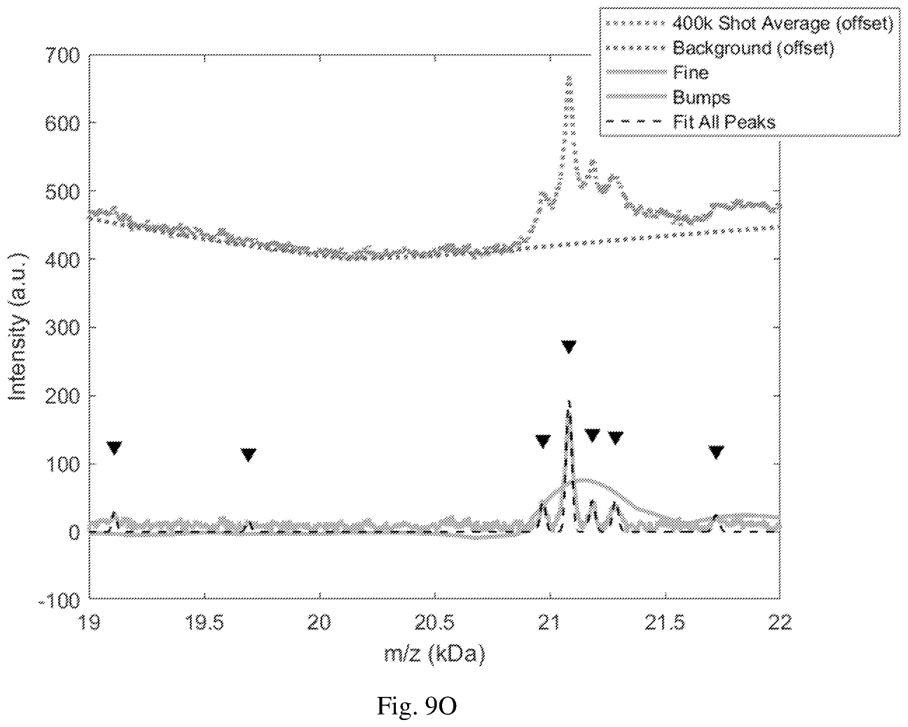

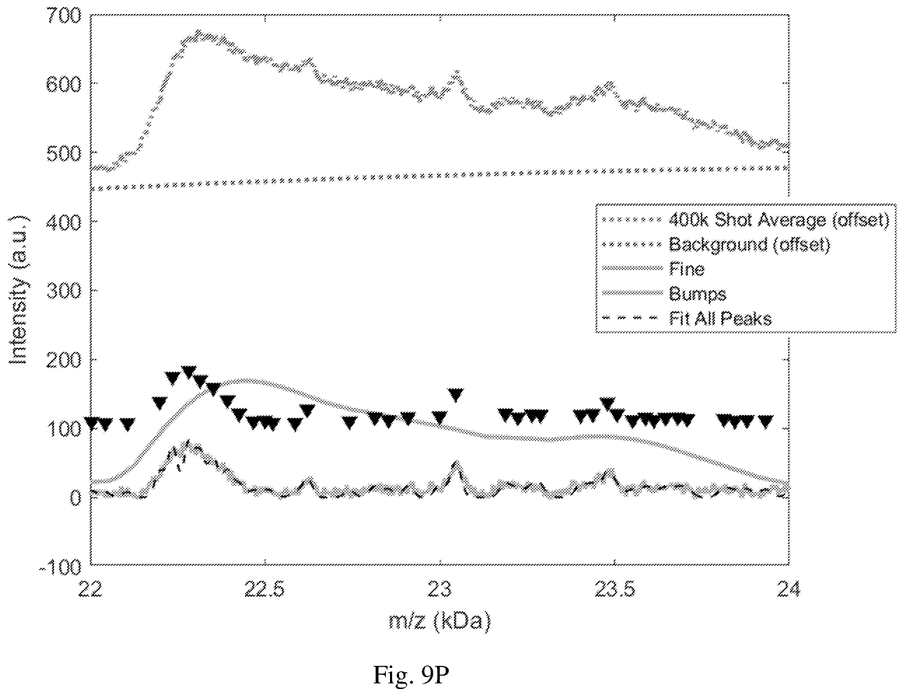

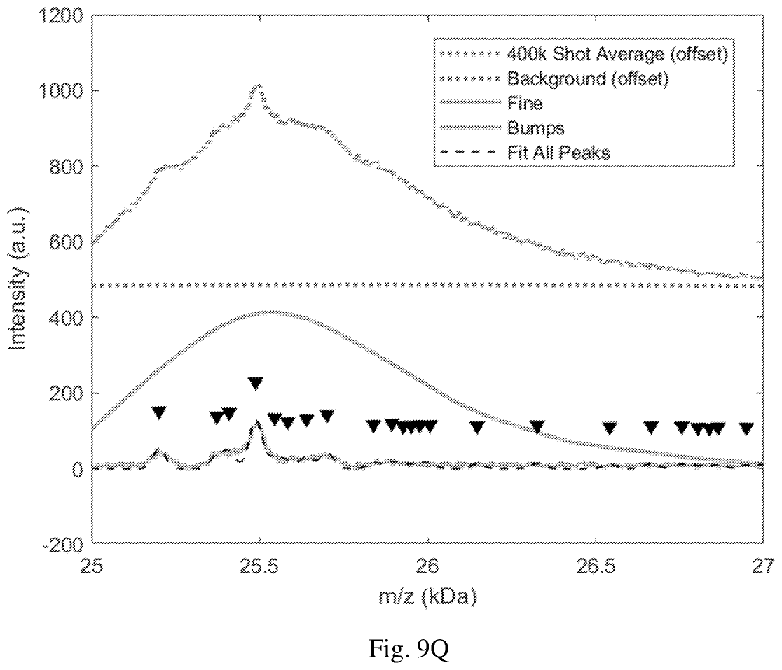

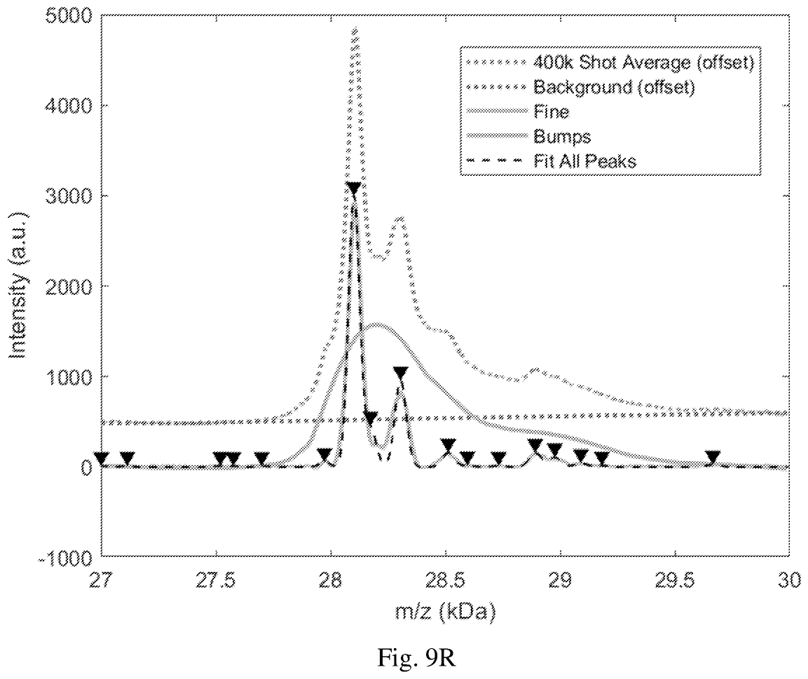

Referring to FIG. 9, a representative, high-resolution unprocessed and processed RapifleX spectrum is illustrated. Each figure shows the unprocessed 400k Shot average Deep MALDI spectrum (901, dotted), the background (902, dotted), the Fine structure (903, solid), the Bumps (904, solid), and the spectral fit (905, dashed) for all peaks (positions noted by the black triangles) for a given range. FIGS. 9A-R show the entire range from m/z=3 to 30 kDa. For clarity the 400k Shot average and background were offset in intensity by a constant amount of: 6000 counts in FIG. 9A, 5000 counts in FIGS. 9B-C, 4000 counts in FIGS. 9D-J, 1000 counts in FIG. 9K, 3000 counts in FIGS. 9L-M, and 3500 counts in FIGS. 9N-R. FIG. 6A shows the full spectrum from 3-30 kDa without any offset for the 400k Shot average.

Referring to FIG. 10, Deep MALDI averaging of the SimulTOF100 spectra is illustrated. Example spectra collected on the SimulTOF100 of an individual raster spectrum (1001, black) and a 400k shot Deep MALDI averaged spectrum (1002, grey) from 7.5 to 9 kDa m/z range. The inset shows the same spectra over the full 3 to 30 kDa range analyzed in this work.

Referring to FIG. 11, peak shape determination of SimulTOF100 MALDI-TOF spectral peaks is shown. FIG. 11A shows sample data (black stars) and peak fit to an asymmetric (solid) and symmetric (dashed) Gaussian. Fit error is shown on the dotted lines. FIG. 11B shows peak shape parameters as a function of m/z. Overall fitted trend are shown with solid lines and the linear (dashed) and quadratic (dotted) piecewise portions for σ_{L} and σ_{R} of the fits are extended past the trend range for reader visibility.

Table S1 provides SimulTOF100 peak shape parameters. In particular, the average peak width parameters for the FWHM, left-, and right-HWHM for the ST100 are given. Results were found to fit well to a single quadratic fit, so mᵢₙₜ was set to 0.

| | a₀ | a₁ | c₀ | c₁ | c₂ | mᵢₙₜ |
|---|---|---|---|---|---|---|
| FWHM | 0 | 0 | 12.398 | −1.15E−03 | 8.16E−08 | 0 |
| σ_{L} | 0 | 0 | 6.342 | −6.69E−04 | 4.60E−08 | 0 |
| σ_{R} | 0 | 0 | 6.057 | −4.85E−04 | 3.56E−08 | 0 |

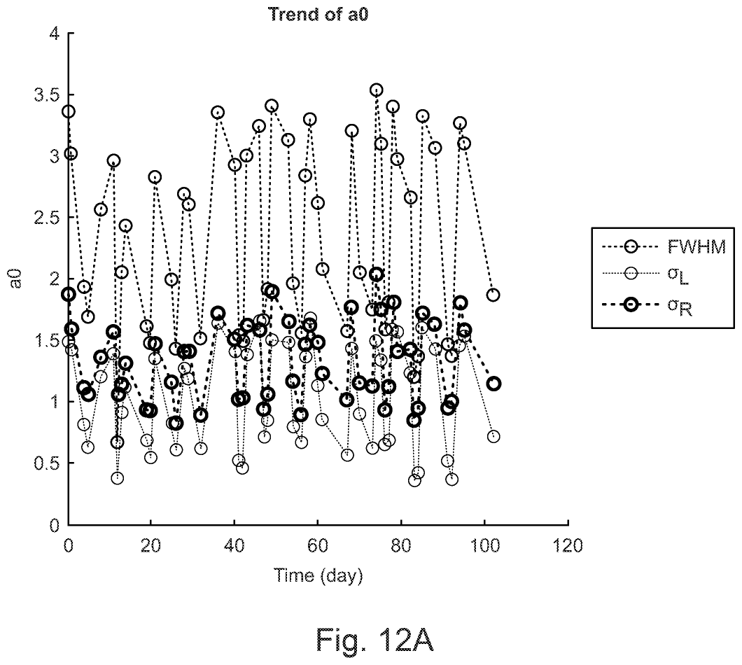

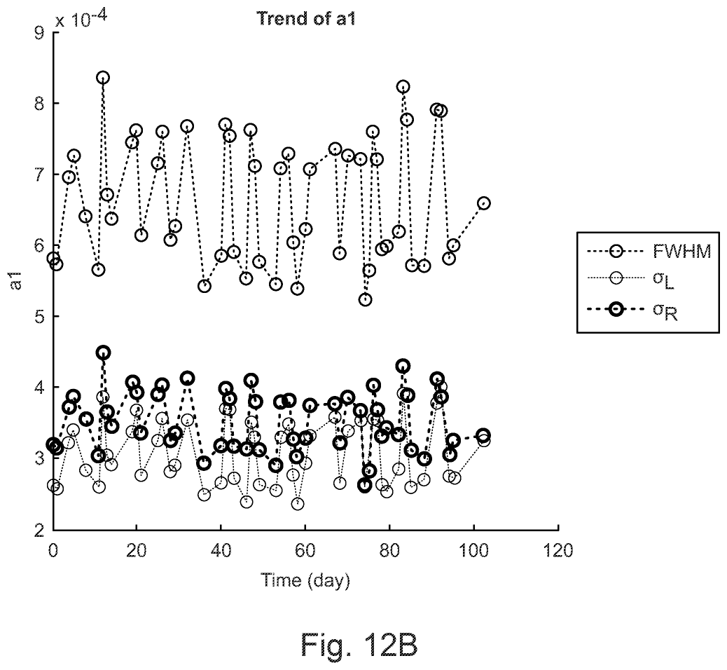

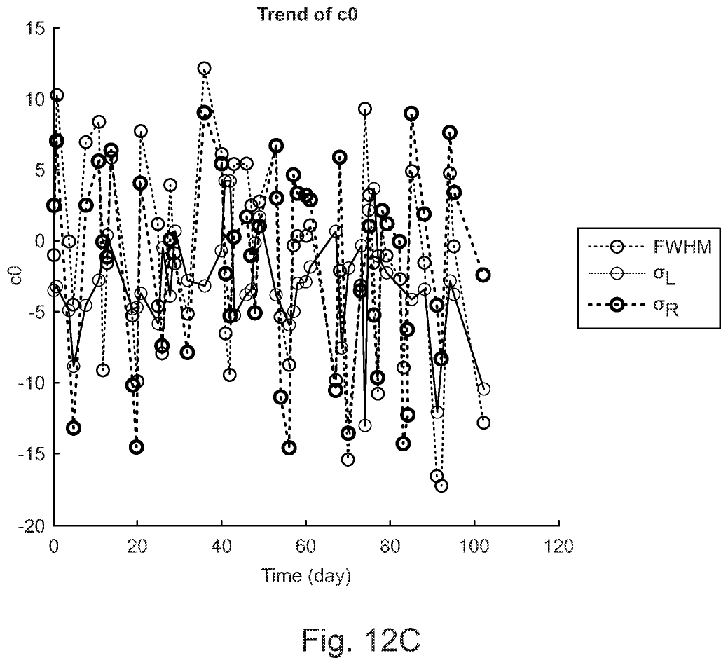

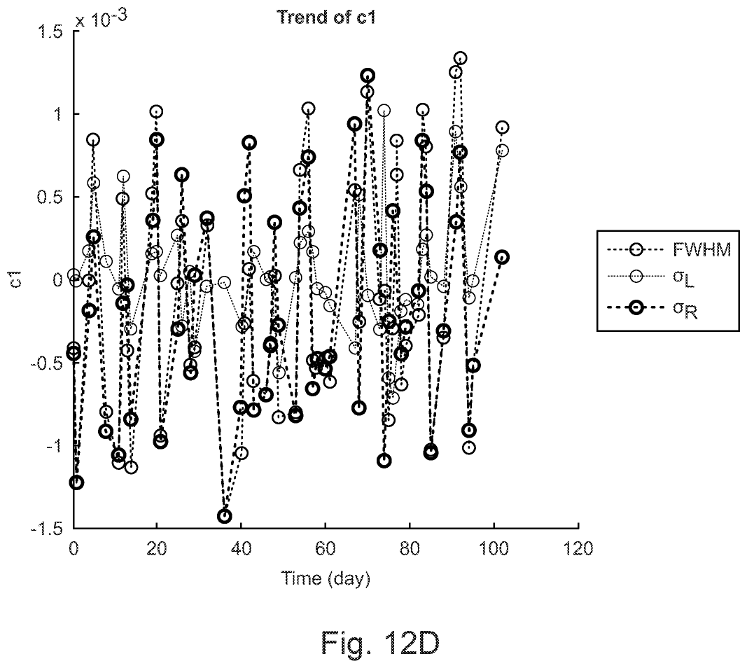

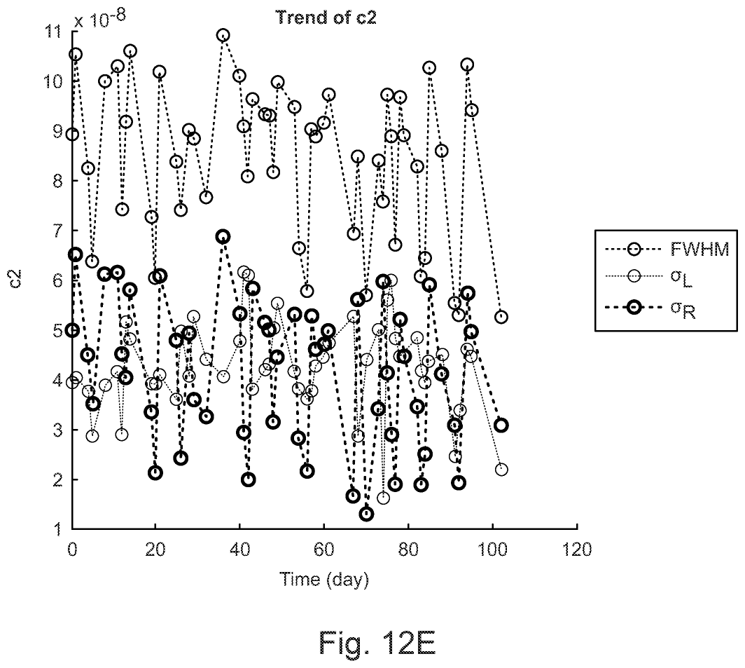

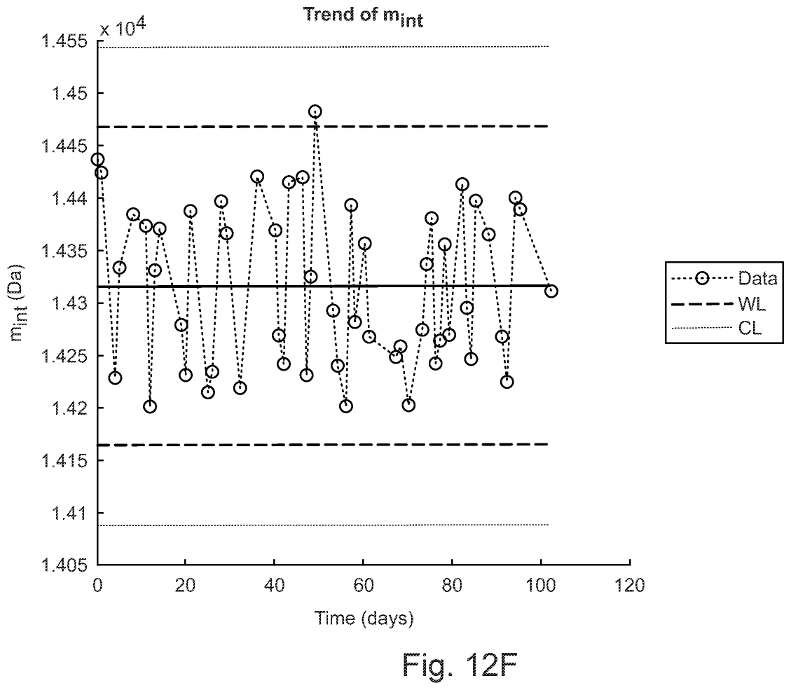

Referring to FIG. 12, the peak shape parameter stability is illustrated. Trend charts for the RapifleX peak shape parameters over the course of >100 days of operation are provided based on the same reference serum sample run on each batch. Trends are shown for (FIG. 12A) a₀, (FIG. 12B) a₁, (FIG. 12C) c₀, (FIG. 12D) c₁, (FIG. 12E) c₂, and (FIG. 12F) mᵢₙₜ. For FIG. 12A-E, the trends for the FWHM, σ_{L}, and σ_{R} are shown. The mᵢₙₜ trend in FIG. 12F shows the warning limit (WL, ±2 standard deviations) and critical limit (CL, ±3 standard deviations). All values show stable trends.

Referring to FIG. 13, dependence of peak shape parameters on m/z assuming averagine is illustrated. Calculated peak fitting trend due to isotope broadening using averagine is shown. Isotopic distribution was calculated based off of a fictional isotope average with an m/z spacing of 1 Da. Peaks were fit to an asymmetric Gaussian as described above.

TABLE S2
Alignment points used for aligning individual
rasters described above on the Bruker RapifleX
m/z

3320.71
4160.27
4718.33
6442.52
6640.88
6891.39
7945.08
8692.87
8926.44
9432.89
11695.73
12876.73
13775.03
14054.90
15140.24
15882.10
17395.14
21084.41
22253.48
25493.56
28103.22
28305.38

TABLE S3
Alignment points used for aligning individual
rasters described above on the SimulTOF100.
m/z

3168.00
4153.48
4183.00
4792.00
5773.00
5802.00
6432.79
6631.06
7202.00
7563.00
7614.00
7934.00
8034.00
8206.35
8684.25
8812.00
8919.00
8994.00
9133.25
9310.00
9427.00
10739.00
10938.00
11527.06
12173.00
12572.38
12864.24
13555.00
13762.87
13881.55
14039.60
14405.00
15127.49
15263.00
15869.06
17253.06
18629.76
21065.65
23024.00
28090.00
28298.00

TABLE S4
Alignment peaks for Deep MALDI spectra
used above for the RapifleX.

3021.15
3027.60
3033.56
3045.91
3051.91
3064.85
3073.13
3090.06
3096.43
3113.06
3135.69
3142.00
3148.54
3160.58
3168.06
3181.15
3187.52
3205.29
3211.72
3221.17
3227.11
3242.72
3248.75
3254.17
3269.63
3274.94
3288.93
3294.49
3300.39
3320.37
3327.38
3333.97
3366.85
3372.43
3401.47
3412.41
3424.23
3433.61
3446.26
3452.39
3468.97
3475.26
3487.86
3494.38
3501.74
3511.96
3519.73
3540.30
3545.34
3556.37
3564.44
3575.32
3583.59
3594.77
3600.61
3630.22
3639.39
3660.31
3684.17
3694.46
3703.15
3711.43
3718.62
3725.46
3731.21
3738.01
3745.78
3761.56
3771.40
3782.23
3802.69
3808.17
3815.13
3823.27
3831.35
3844.18
3849.67
3898.99
3912.32
3929.04
3941.61
3961.31
3971.13
3984.21
3995.90
4017.49
4024.09
4039.39
4051.97
4057.75
4062.42
4097.55
4106.15
4115.87
4130.45
4142.39
4160.16
4166.49
4181.71
4192.24
4201.71
4213.91
4224.39
4247.45
4258.68
4271.49
4291.38
4299.95
4323.09
4348.38
4367.94
4386.39
4399.47
4412.97
4419.60
4426.38
4441.39
4451.54
4465.03
4474.13
4480.40
4498.52
4514.34
4531.93
4544.77
4555.04
4577.30
4584.58
4594.38
4604.61
4633.96
4650.29
4672.15
4685.61
4693.19
4704.52
4718.12
4728.42
4737.64
4745.54
4762.90
4783.40
4797.93
4821.18
4831.30
4852.28
4863.40
4874.62
4891.53
4899.87
4918.87
4929.41
4944.46
4952.17
4967.16
4974.07
4993.87
5009.51
5029.13
5040.16
5052.66
5066.93
5073.69
5080.86
5108.76
5114.95
5121.39
5137.96
5152.73
5187.40
5196.03
5202.96
5227.45
5237.61
5256.37
5283.23
5291.20
5299.06
5309.84
5327.16
5336.56
5356.17
5370.79
5381.42
5400.98
5414.80
5423.49
5437.53
5458.17
5482.65
5500.96
5511.57
5519.60
5529.56
5555.50
5566.59
5581.93
5592.75
5599.42
5637.00
5644.13
5685.75
5707.03
5716.28
5729.76
5744.76
5762.87
5772.81
5786.67
5804.91
5816.78
5831.61
5850.26
5863.80
5873.00
5883.12
5890.51
5917.51
5946.30
5971.76
5997.44
6016.59
6037.68
6055.63
6071.33
6082.09
6090.69
6098.99
6118.66
6137.87
6151.49
6160.78
6182.00
6194.59
6206.11
6216.88
6225.14
6263.51
6281.38
6295.69
6306.84
6314.90
6323.82
6339.29
6353.50
6362.09
6380.64
6408.44
6433.00
6442.57
6463.70
6486.57
6508.12
6529.02
6541.60
6565.19
6597.58
6605.25
6625.00
6641.07
6663.74
6683.98
6706.12
6728.51
6738.99
6751.95
6769.58
6783.95
6803.13
6813.48
6821.61
6847.45
6868.67
6891.07
6901.62
6908.16
6931.32
6950.78
6962.23
6978.72
6993.62
7003.03
7012.45
7031.09
7043.10
7054.25
7063.38
7071.48
7082.23
7093.23
7107.61
7138.86
7151.56
7164.16
7173.00
7197.51
7211.76
7229.77
7254.20
7271.26
7281.70
7296.51
7308.22
7329.84
7343.32
7355.51
7365.61
7385.10
7399.43
7423.53
7433.81
7451.07
7462.35
7480.65
7492.67
7515.24
7547.29
7574.16
7584.66
7594.47
7607.30
7626.50
7650.95
7664.30
7677.59
7687.85
7720.16
7735.25
7748.32
7774.24
7792.95
7804.62
7825.42
7833.29
7844.80
7877.31
7889.84
7922.31
7944.81
7955.60
7965.98
7976.16
8003.86
8024.35
8036.02
8047.67
8057.95
8068.79
8088.79
8129.39
8139.33
8149.57
8158.47
8171.73
8180.84
8215.45
8235.04
8245.76
8255.63
8267.75
8279.35
8288.67
8323.88
8337.72
8351.76
8371.43
8396.79
8419.57
8437.67
8458.49
8473.84
8485.69
8497.53
8514.39
8539.15
8574.33
8588.73
8596.95
8620.23
8637.79
8667.44
8693.53
8702.54
8713.60
8736.60
8750.37
8776.97
8803.21
8821.79
8831.07
8841.66
8853.12
8879.19
8899.71
8909.16
8926.58
8946.08
8970.72
8984.40
9008.13
9028.22
9045.65
9087.45
9106.55
9134.61
9146.03
9173.13
9197.35
9216.02
9251.85
9271.68
9292.11
9312.77
9327.16
9371.22
9383.40
9404.29
9433.25
9446.99
9476.03
9495.63
9513.20
9523.37
9540.38
9583.76
9595.59
9607.88
9630.56
9639.85
9653.89
9665.43
9681.06
9708.78
9723.84
9737.55
9785.53
9798.30
9811.35
9862.59
9874.64
9884.52
9895.19
9904.34
9929.48
9944.99
9955.50
9968.35
9995.37
10015.71
10062.40
10087.66
10106.46
10145.68
10171.72
10193.11
10218.78
10242.52
10264.95
10290.79
10312.55
10352.24
10374.85
10397.97
10427.12
10445.84
10458.56
10488.93
10502.77
10517.77
10544.46
10561.79
10591.08
10633.09
10647.89
10656.99
10673.95
10721.68
10732.88
10740.45
10750.27
10791.13
10809.99
10838.36
10850.55
10861.46
10894.33
10907.85
10929.70
10968.77
10979.88
11011.72
11059.62
11073.76
11113.29
11158.22
11172.89
11186.28
11202.78
11239.44
11261.67
11274.86
11289.37
11305.17
11317.76
11349.10
11383.25
11395.64
11419.74
11451.58
11463.34
11487.50
11504.47
11525.68
11539.71
11553.68
11565.03
11578.78
11617.09
11638.27
11660.49
11681.35
11695.14
11709.15
11741.86
11773.43
11796.63
11840.68
11887.94
11903.76
11918.21
11932.48
11948.23
11962.76
11976.16
11995.65
12009.79
12036.68
12062.47
12075.62
12124.02
12138.17
12152.00
12166.94
12191.20
12293.03
12306.91
12347.24
12360.25
12394.94
12423.77
12462.49
12516.12
12568.45
12585.08
12602.91
12620.67
12643.56
12667.24
12683.97
12700.88
12716.54
12733.47
12746.00
12792.09
12809.35
12833.26
12858.60
12876.01
12888.05
12898.42
12911.05
12957.51
12974.62
12997.00
13039.27
13057.19
13081.90
13100.33
13123.68
13141.37
13164.64
13181.68
13208.15
13255.63
13279.00
13306.56
13327.51
13348.60
13369.26
13383.25
13403.06
13421.34
13439.43
13521.62
13534.90
13551.37
13578.46
13620.93
13642.32
13687.63
13732.01
13757.62
13774.64
13789.92
13804.24
13852.92
13893.87
13911.63
13933.63
13950.93
13981.35
13995.75
14038.70
14053.96
14069.62
14100.79
14117.84
14136.78
14158.25
14177.45
14207.86
14245.56
14261.31
14274.20
14304.74
14323.20
14343.14
14366.79
14383.45
14432.96
14447.31
14460.82
14481.83
14496.79
14512.81
14531.85
14543.19
14558.34
14583.32
14598.50
14654.14
14680.00
14705.47
14738.64
14773.09
14789.75
14797.08
14813.29
14832.47
14850.44
14864.83
14889.28
14939.14
14953.02
14978.70
15082.30
15095.13
15140.25
15156.45
15167.67
15183.59
15303.31
15323.18
15345.80
15363.30
15375.86
15391.97
15445.39
15518.92
15552.61
15573.89
15592.00
15730.73
15748.82
15881.68
15901.75
15920.05
15937.97
16001.30
16044.11
16063.38
16087.57
16106.26
16128.76
16206.74
16269.15
16291.12
16313.22
16332.18
16401.02
16598.44
16637.73
16653.43
16668.06
16686.41
16704.62
16725.85
16746.41
16936.90
16956.86
16996.95
17038.22
17086.11
17138.33
17165.77
17267.10
17289.33
17395.29
17422.56
17472.12
17492.10
17557.54
17600.64
17622.29
17648.88
17814.32
17881.35
18025.83
18049.81
18283.40
18588.29
18644.85
18806.46
18857.24
19044.18
19110.35
19576.12
19694.60
20336.22
20546.91
20970.56
21083.65
21182.29
21294.96
21479.45
21723.22
22204.76
22241.26
22278.76
22315.64
22355.21
22397.00
22618.74
23047.67
23187.44
23476.56
25202.40
25405.93
25488.17
28104.40
28303.83
28511.15

TABLE S5
Alignment peaks for Deep MALDI spectra
used above for the SimulTOF100.

3044.72
3088.88
3111.46
3139.93
3157.23
3201.94
3218.95
3241.99
3265.78
3317.93
3369.26
3398.46
3423.25
3446.38
3467.74
3487.16
3556.05
3682.06
3690.97
3708.08
3725.99
3777.62
3820.58
3842.97
3892.70
3908.75
3955.74
3977.29
4013.72
4052.54
4101.26
4154.53
4186.14
4208.81
4245.76
4266.11
4291.81
4342.38
4362.15
4382.77
4406.40
4434.78
4458.55
4472.15
4509.02
4567.75
4587.20
4598.76
4627.20
4645.45
4675.96
4697.22
4711.44
4723.31
4757.32
4790.94
4814.34
4822.59
4842.83
4856.22
4892.05
4923.24
4938.13
4962.73
4983.68
4998.93
5042.97
5067.09
5104.71
5142.67
5174.26
5186.12
5196.40
5222.80
5248.89
5289.54
5327.21
5360.81
5406.75
5417.52
5429.34
5451.66
5474.62
5491.76
5520.63
5557.89
5573.14
5587.43
5601.63
5633.13
5707.46
5731.39
5750.99
5762.75
5777.17
5793.26
5822.22
5840.19
5864.02
5908.07
5935.56
5964.08
5989.53
6007.60
6028.37
6063.19
6074.44
6082.52
6088.71
6109.69
6146.04
6173.16
6196.36
6211.35
6224.89
6286.19
6300.09
6311.96
6332.13
6389.91
6398.24
6433.23
6444.22
6479.13
6497.59
6521.24
6529.48
6537.53
6588.41
6619.31
6632.17
6641.72
6665.38
6675.10
6696.17
6721.15
6729.45
6738.46
6761.21
6794.67
6805.98
6837.92
6860.30
6881.27
6893.45
6903.47
6930.11
6940.93
6952.58
6969.23
6985.38
6993.11
7020.27
7034.09
7044.72
7055.43
7072.33
7084.67
7097.00
7104.72
7129.41
7142.09
7154.27
7188.46
7198.75
7211.95
7243.48
7260.06
7271.89
7284.74
7296.40
7319.71
7332.72
7344.95
7357.12
7389.29
7414.58
7422.92
7437.37
7443.39
7470.13
7504.48
7564.13
7573.44
7586.08
7611.49
7645.29
7653.28
7667.46
7677.18
7723.68
7738.26
7768.22
7782.37
7811.88
7821.14
7833.40
7853.87
7867.06
7879.53
7914.00
7934.52
7945.12
7960.01
7975.93
7982.92
8015.97
8037.76
8047.53
8059.06
8090.29
8120.15
8124.38
8128.93
8140.57
8149.69
8160.00
8205.16
8216.01
8244.92
8256.75
8270.28
8313.81
8327.23
8339.94
8360.58
8369.34
8382.39
8387.29
8392.21
8411.43
8428.15
8443.47
8475.24
8487.70
8504.09
8529.05
8563.57
8581.60
8592.71
8627.05
8637.81
8657.44
8682.98
8691.95
8702.41
8727.52
8740.04
8765.95
8792.92
8811.27
8824.21
8868.62
8891.07
8916.20
8926.11
8959.69
8973.39
8997.87
9017.97
9034.14
9062.62
9075.46
9094.08
9124.36
9135.02
9149.34
9159.45
9168.43
9173.16
9179.89
9203.62
9241.30
9260.61
9282.93
9288.00
9292.58
9316.22
9351.96
9360.47
9373.18
9393.47
9423.18
9436.62
9463.38
9482.49
9497.43
9506.22
9531.58
9573.57
9589.70
9595.56
9624.10
9631.79
9644.90
9668.66
9699.15
9714.05
9724.83
9734.39
9744.40
9788.19
9799.92
9851.39
9866.49
9874.01
9887.50
9919.54
9935.13
9949.97
9991.21
10008.17
10054.37
10062.69
10070.55
10078.25
10085.95
10097.96
10133.74
10139.87
10156.29
10180.01
10187.08
10206.30
10231.80
10252.81
10283.57
10301.25
10341.95
10362.99
10394.75
10413.73
10446.44
10477.40
10492.39
10507.93
10532.50
10583.98
10623.38
10633.63
10646.67
10667.81
10676.31
10685.22
10713.94
10720.89
10729.18
10739.05
10748.30
10781.58
10796.90
10836.63
10851.01
10879.87
10918.92
10927.89
10940.66
10951.01
10959.47
10968.90
10982.32
10994.68
11000.10
11005.48
11045.01
11059.16
11068.89
11080.28
11102.09
11147.95
11190.33
11254.59
11266.55
11288.73
11302.10
11310.88
11340.60
11351.91
11370.65
11381.49
11389.72
11394.52
11401.71
11411.35
11441.87
11453.10
11480.33
11487.75
11495.22
11515.72
11528.89
11558.90
11584.71
11604.03
11627.03
11649.75
11683.77
11722.81
11731.57
11747.55
11761.76
11782.63
11794.33
11830.51
11860.90
11877.53
11908.77
11938.74
11950.57
11955.87
11960.80
12023.50
12051.47
12064.90
12108.94
12141.83
12156.60
12180.76
12205.82
12275.10
12280.09
12285.17
12296.79
12331.48
12345.47
12354.08
12366.37
12385.08
12410.84
12446.43
12453.12
12504.66
12557.44
12573.97
12590.78
12609.18
12632.46
12656.08
12672.18
12690.63
12733.82
12780.76
12796.85
12847.46
12856.03
12864.98
12876.73
12889.06
12900.86
12923.97
12948.40
12963.51
12981.28
13029.92
13045.59
13068.96
13088.49
13112.73
13131.07
13154.13
13169.64
13188.58
13244.08
13272.96
13294.47
13316.07
13335.98
13359.32
13372.18
13391.06
13410.25
13507.96
13524.95
13566.66
13588.57
13608.90
13630.13
13661.65
13675.23
13723.24
13746.84
13763.08
13779.91
13792.41
13843.34
13866.55
13882.22
13898.85
13939.30
13974.77
14041.44
14062.78
14089.45
14105.58
14140.60
14151.56
14168.60
14194.32
14247.22
14258.17
14293.68
14307.40
14353.24
14369.72
14421.97
14438.10
14471.25
14482.31
14495.81
14528.47
14546.52
14580.01
14642.16
14667.83
14690.25
14779.99
14819.68
14840.68
14862.46
14878.18
14970.79
15128.18
15148.25
15168.16
15185.61
15226.63
15291.20
15311.71
15334.12
15352.26
15372.89
15390.07
15437.61
15494.79
15509.96
15539.96
15558.22
15575.08
15638.54
15740.99
15763.42
15869.10
15890.56
15913.58
15951.37
15969.99
16032.53
16075.01
16093.66
16115.59
16237.76
16257.43
16279.92
16299.27
16317.64
16468.51
16484.28
16503.34
16521.09
16542.17
16631.93
16653.99
16668.87
16687.40
16706.59
16716.31
16733.17
16832.05
16853.97
16926.89
17023.67
17125.45
17151.24
17253.66
17381.91
17402.70
17460.49
17588.89
17608.47
17640.31
17667.12
17799.31
17825.51
17874.96
18015.95
18039.97
18168.31
18269.61
18443.37
18474.64
18498.85
18574.91
18629.87
18726.98
18757.68
18795.17
18831.87
18856.22
18894.93
19093.63
19145.52
19377.18
19479.06
19561.12
20398.48
20521.72
20545.26
20575.05
20596.89
20793.11
20828.38
20929.41
20960.51
21067.14
21166.56
21266.43
21370.23
21477.24
21603.69
21707.67
21757.35
21805.52
21855.12
21976.17
22187.17
22219.66
22254.36
22287.95
22320.74
22352.71
22373.30
22395.94
22432.72
22605.96
22805.01
23033.41
23172.57
23376.98
23465.14
23562.86
25188.48
25402.48
25476.63
25567.35
25680.23
27964.53
28094.06
28190.12
28298.85
28403.23
28509.99
28613.52
28717.54
28882.58
28975.40
29079.76
29188.59

TABLE S6
Spectral alignment ranges. The different ranges were
determined visually based on where there appeared
to be a spacing in the detected peaks.

| | Rapiflex | | SimulTOF100 | |
|---|---|---|---|---|
| | Begin m/z | End m/z | Begin m/z | End m/z |
| Range 1 | 3000.0 | 5167.9 | 3000.0 | 4998.9 |
| Range 2 | 5167.9 | 9839.4 | 4998.9 | 9799.9 |
| Range 3 | 9839.4 | 16173 | 9799.9 | 16116 |
| Range 4 | 16173 | 30000 | 16116 | 30000 |

TABLE S7
Peak list for the RapifleX consisting of 1657 peaks.

3015.81
3021.69
3027.40
3033.70
3046.40
3051.06
3054.47
3059.82
3069.11
3072.88
3076.49
3089.80
3096.06
3100.22
3112.88
3117.13
3120.77
3123.96
3127.52
3135.35
3140.92
3144.25
3148.87
3152.93
3155.84
3160.30
3164.95
3168.30
3173.40
3176.47
3181.05
3186.34
3202.04
3205.00
3210.49
3221.10
3227.04
3230.81
3243.68
3249.51
3253.77
3259.93
3264.92
3269.89
3273.90
3280.54
3289.41
3295.87
3300.58
3314.31
3320.18
3327.17
3332.07
3334.80
3340.24
3348.91
3355.69
3359.22
3362.86
3369.62
3374.79
3379.93
3383.41
3389.13
3401.96
3406.53
3411.71
3424.49
3433.18
3446.37
3452.02
3455.68
3469.03
3474.83
3484.65
3489.61
3495.35
3501.48
3511.92
3518.01
3522.70
3528.17
3532.84
3538.35
3544.20
3556.48
3564.40
3571.95
3577.28
3581.37
3584.85
3588.61
3593.43
3600.15
3606.98
3611.44
3615.71
3618.27
3622.43
3625.86
3630.28
3634.94
3639.55
3645.26
3650.77
3658.97
3663.05
3667.71
3672.17
3675.45
3683.97
3687.74
3694.31
3699.91
3703.88
3711.40
3718.14
3722.91
3728.02
3731.20
3734.58
3738.56
3745.33
3749.35
3760.93
3766.25
3771.15
3782.31
3787.19
3791.47
3794.82
3799.71
3805.50
3809.31
3814.85
3817.90
3823.15
3831.32
3838.30
3843.61
3848.40
3856.77
3860.22
3866.70
3873.56
3880.02
3882.83
3886.86
3891.80
3898.81
3912.38
3917.40
3922.47
3928.93
3938.06
3941.32
3947.65
3954.51
3960.83
3964.82
3968.25
3971.85
3977.72
3984.29
3989.90
3995.35
4004.94
4010.12
4013.43
4017.19
4023.49
4028.91
4038.68
4048.04
4057.13
4062.29
4076.49
4080.34
4084.60
4090.59
4097.59
4105.77
4114.17
4116.91
4121.23
4130.20
4133.82
4142.23
4146.87
4153.56
4160.02
4166.29
4170.81
4176.20
4181.73
4188.76
4192.15
4198.22
4202.89
4213.92
4218.08
4225.80
4235.71
4240.53
4247.52
4258.11
4263.40
4271.11
4277.34
4291.53
4299.89
4313.70
4323.42
4327.82
4335.41
4340.07
4348.31
4354.49
4358.26
4368.04
4372.18
4385.97
4392.93
4400.64
4405.68
4413.05
4419.43
4426.20
4440.72
4451.82
4464.93
4475.22
4481.01
4498.00
4506.19
4514.34
4521.24
4527.24
4533.62
4538.82
4542.85
4547.29
4554.42
4562.38
4569.72
4573.32
4577.91
4584.70
4594.27
4604.35
4609.34
4616.51
4620.87
4627.38
4633.99
4646.35
4651.75
4659.58
4663.98
4671.95
4678.05
4684.28
4692.60
4699.16
4703.41
4709.05
4717.81
4728.78
4734.02
4737.23
4740.13
4745.39
4762.64
4766.75
4770.83
4782.63
4792.74
4797.32
4803.10
4811.25
4820.31
4831.02
4843.68
4848.23
4851.57
4854.98
4862.99
4873.37
4883.23
4891.02
4900.11
4908.30
4919.84
4928.80
4936.47
4944.02
4951.26
4959.06
4962.66
4967.30
4974.73
4979.50
4984.44
4993.28
5001.91
5010.16
5016.93
5028.55
5038.49
5045.11
5051.35
5058.30
5064.91
5070.17
5073.91
5081.99
5091.02
5101.30
5108.54
5115.79
5122.77
5128.76
5138.60
5144.71
5152.03
5163.00
5166.94
5177.26
5182.27
5187.95
5192.56
5197.58
5203.82
5212.88
5218.43
5227.64
5234.23
5238.03
5246.53
5254.38
5261.22
5271.22
5275.66
5280.52
5284.51
5290.58
5298.93
5305.56
5310.27
5318.39
5323.49
5328.07
5336.49
5341.15
5347.26
5356.15
5369.87
5376.44
5385.89
5393.72
5401.18
5415.07
5424.55
5437.86
5447.04
5458.29
5463.20
5467.72
5477.53
5482.45
5500.27
5504.96
5512.62
5521.33
5529.40
5535.75
5542.99
5550.14
5555.70
5559.45
5566.71
5582.39
5593.56
5599.78
5606.53
5612.08
5623.10
5629.76
5637.14
5643.47
5654.00
5661.05
5670.84
5679.37
5685.70
5696.71
5706.63
5715.98
5720.72
5725.00
5729.60
5733.74
5738.50
5745.86
5755.54
5761.75
5768.41
5772.44
5778.27
5786.51
5791.13
5807.89
5817.51
5821.38
5831.77
5837.29
5842.64
5850.22
5868.62
5873.54
5884.32
5890.06
5899.26
5904.97
5911.80
5917.46
5923.35
5927.55
5931.07
5939.32
5946.45
5952.60
5958.41
5962.92
5971.71
5976.28
5982.68
5987.67
5996.88
6010.71
6016.38
6025.41
6037.87
6043.26
6048.20
6055.09
6060.09
6067.66
6073.11
6077.70
6083.64
6091.87
6099.41
6108.95
6118.73
6124.62
6132.56
6139.41
6151.52
6160.34
6166.79
6170.71
6174.22
6183.51
6191.82
6196.06
6206.01
6216.14
6220.58
6224.70
6229.24
6234.77
6243.74
6249.64
6254.01
6263.55
6269.41
6280.15
6285.78
6295.73
6306.85
6316.35
6325.20
6339.42
6344.42
6354.03
6362.32
6368.13
6376.69
6380.79
6389.87
6393.71
6400.45
6408.83
6432.36
6442.41
6451.04
6456.16
6464.17
6473.00
6482.59
6486.58
6497.42
6507.49
6512.82
6529.74
6541.28
6551.13
6565.33
6574.97
6581.20
6597.23
6605.37
6624.95
6632.02
6641.07
6663.74
6678.21
6684.38
6700.67
6706.53
6711.86
6728.38
6738.89
6751.08
6755.68
6770.11
6783.86
6794.91
6802.85
6808.68
6814.79
6820.73
6827.49
6840.96
6847.23
6858.73
6868.82
6881.00
6890.98
6902.61
6910.24
6923.19
6930.78
6941.36
6950.64
6964.98
6971.27
6978.90
6987.20
6993.54
7003.17
7008.25
7013.44
7018.84
7025.13
7030.77
7043.02
7054.20
7063.93
7071.75
7082.33
7093.66
7098.79
7106.36
7118.26
7124.66
7139.14
7151.57
7159.42
7164.86
7173.55
7181.66
7185.73
7189.92
7197.36
7210.71
7218.73
7230.96
7240.97
7246.69
7254.02
7262.69
7271.17
7281.29
7285.76
7289.97
7295.51
7308.21
7321.48
7330.08
7342.90
7355.61
7365.39
7373.42
7384.77
7393.66
7399.14
7408.13
7423.38
7433.78
7438.03
7451.00
7458.61
7462.56
7480.53
7487.18
7494.57
7499.22
7515.80
7522.54
7528.95
7538.39
7546.59
7551.57
7563.04
7573.98
7584.72
7595.21
7606.80
7614.72
7620.05
7626.05
7648.33
7654.27
7664.25
7677.39
7687.42
7696.05
7705.19
7718.72
7728.05
7734.54
7747.68
7756.63
7761.22
7768.27
7774.06
7780.23
7785.67
7792.91
7804.22
7809.06
7815.21
7823.26
7832.66
7841.43
7845.72
7855.08
7863.60
7874.07
7880.06
7888.38
7908.10
7922.06
7934.13
7944.64
7955.53
7965.72
7976.00
7987.12
8002.97
8017.49
8023.63
8035.39
8040.13
8047.41
8057.94
8068.41
8075.59
8088.95
8100.31
8107.70
8114.78
8122.07
8128.89
8134.07
8139.59
8149.23
8158.65
8168.83
8179.37
8196.52
8204.89
8215.21
8234.59
8243.23
8254.56
8261.31
8267.61
8280.04
8288.77
8296.19
8308.54
8316.06
8323.67
8337.55
8351.27
8359.97
8370.76
8383.62
8396.33
8409.78
8419.09
8428.16
8437.12
8450.42
8457.33
8462.53
8474.21
8485.50
8496.04
8512.50
8520.10
8532.29
8538.37
8551.92
8556.91
8561.14
8565.68
8574.02
8586.89
8595.72
8603.11
8613.58
8619.60
8637.49
8647.96
8654.70
8667.38
8681.90
8693.25
8702.19
8712.55
8724.28
8730.42
8737.38
8745.53
8749.87
8759.95
8765.56
8772.36
8777.09
8791.56
8803.38
8821.59
8832.20
8841.99
8847.42
8853.36
8864.65
8879.24
8899.15
8908.52
8926.40
8937.05
8947.25
8958.28
8971.70
8985.80
8992.23
9000.38
9009.06
9014.82
9028.04
9039.40
9044.46
9058.62
9068.64
9086.74
9097.23
9106.56
9114.71
9133.96
9145.86
9153.34
9164.01
9171.95
9177.34
9183.79
9191.13
9197.97
9209.81
9215.86
9223.72
9232.63
9243.12
9251.98
9271.35
9293.26
9301.33
9305.77
9312.29
9327.09
9337.60
9349.53
9361.46
9371.31
9383.43
9390.16
9404.08
9420.97
9433.39
9439.36
9447.50
9458.62
9466.95
9476.39
9497.31
9507.58
9515.26
9523.74
9540.08
9548.92
9564.86
9569.48
9576.22
9583.71
9595.03
9607.13
9629.54
9639.70
9654.28
9666.21
9672.84
9680.52
9698.38
9709.91
9716.08
9724.29
9736.89
9747.47
9755.71
9767.41
9786.02
9798.25
9809.06
9825.22
9838.44
9845.87
9861.04
9872.00
9882.14
9888.43
9896.21
9905.28
9910.30
9922.58
9929.44
9937.54
9945.49
9956.08
9966.93
9981.71
9993.41
10001.96
10015.71
10032.39
10041.13
10046.84
10057.42
10067.98
10084.83
10092.68
10100.64
10108.92
10116.78
10122.48
10128.31
10136.50
10145.66
10152.02
10157.05
10165.16
10170.63
10178.17
10184.68
10196.80
10208.87
10218.15
10224.94
10230.63
10236.29
10242.72
10264.83
10270.33
10278.82
10290.93
10312.44
10321.54
10328.72
10345.42
10352.79
10361.39
10374.58
10385.78
10391.00
10396.86
10408.56
10426.05
10434.61
10445.30
10458.20
10467.56
10476.61
10489.25
10501.86
10517.47
10534.69
10544.70
10560.85
10569.52
10575.74
10590.94
10605.56
10614.61
10623.47
10632.72
10647.90
10657.15
10673.58
10679.34
10683.92
10690.13
10703.41
10711.11
10721.46
10730.34
10739.81
10745.93
10767.90
10774.53
10782.35
10790.86
10810.11
10822.66
10836.94
10849.74
10856.50
10862.63
10871.97
10881.10
10893.40
10900.73
10909.10
10920.91
10929.81
10941.47
10952.26
10969.09
10977.85
10986.77
10997.08
11009.83
11019.98
11029.54
11034.99
11048.63
11058.52
11066.80
11077.83
11087.71
11093.24
11100.71
11114.05
11121.79
11130.73
11143.07
11149.00
11158.50
11175.95
11191.91
11204.14
11216.31
11228.33
11239.81
11251.38
11264.71
11271.48
11278.90
11290.74
11303.25
11316.16
11323.16
11334.27
11344.06
11349.35
11356.30
11361.13
11374.00
11383.69
11394.08
11402.94
11420.02
11431.42
11438.59
11447.53
11455.54
11469.54
11476.98
11487.26
11504.56
11513.72
11526.17
11540.16
11556.08
11564.31
11571.09
11582.81
11591.58
11605.17
11617.71
11629.50
11638.86
11660.46
11667.06
11681.18
11695.11
11708.36
11714.99
11722.08
11733.54
11741.91
11751.22
11759.76
11774.33
11789.53
11795.86
11801.93
11816.73
11827.50
11841.13
11859.60
11873.25
11881.10
11888.28
11904.65
11918.37
11932.13
11948.06
11963.27
11974.73
11984.40
11995.85
12006.04
12013.33
12021.43
12037.17
12051.39
12062.54
12075.16
12082.12
12095.33
12102.60
12109.05
12122.94
12131.44
12138.54
12151.34
12167.42
12178.18
12183.55
12191.83
12207.49
12217.27
12238.46
12252.80
12262.81
12271.10
12280.64
12293.22
12300.45
12307.71
12327.25
12343.08
12350.79
12361.39
12376.42
12395.82
12409.90
12422.97
12443.01
12456.12
12462.38
12480.81
12494.74
12502.78
12517.60
12529.33
12539.89
12557.04
12568.58
12585.17
12603.68
12620.97
12634.02
12644.12
12667.15
12683.81
12702.05
12707.58
12719.39
12733.63
12745.35
12757.69
12776.21
12792.48
12809.35
12833.46
12846.30
12858.19
12866.18
12876.15
12888.09
12898.08
12912.28
12926.02
12937.82
12957.16
12974.87
12995.89
13007.57
13018.26
13039.38
13056.66
13070.53
13082.12
13100.47
13112.88
13124.12
13142.05
13157.38
13164.43
13182.26
13207.47
13229.65
13242.66
13255.55
13267.05
13283.27
13305.18
13327.33
13347.81
13369.86
13389.37
13404.29
13421.25
13433.97
13440.15
13464.36
13472.86
13483.03
13493.85
13502.96
13510.90
13518.56
13533.67
13550.31
13569.59
13577.13
13599.08
13620.85
13630.51
13642.53
13651.65
13667.87
13688.02
13697.53
13710.71
13732.19
13740.58
13757.78
13774.56
13789.98
13803.75
13821.44
13833.78
13852.73
13873.83
13885.27
13893.75
13912.00
13923.35
13934.42
13951.14
13981.14
13988.41
13995.82
14005.38
14038.58
14053.80
14069.99
14100.71
14117.91
14141.20
14158.81
14166.12
14177.63
14185.90
14192.75
14206.31
14216.57
14247.85
14261.15
14273.48
14281.44
14290.27
14304.25
14312.20
14322.89
14332.43
14342.40
14355.46
14366.84
14383.31
14395.17
14417.34
14432.82
14446.79
14459.91
14469.42
14482.76
14496.60
14511.55
14523.32
14533.21
14547.36
14560.02
14567.02
14578.65
14605.09
14616.22
14622.87
14630.13
14640.85
14654.25
14680.10
14696.56
14705.46
14715.29
14727.41
14738.49
14747.95
14755.05
14774.79
14792.36
14809.58
14819.58
14831.54
14842.77
14853.53
14865.60
14873.23
14900.61
14909.44
14918.81
14928.74
14941.84
14951.25
14968.25
14979.26
14999.38
15017.08
15028.40
15038.32
15057.95
15069.63
15080.51
15092.78
15105.40
15124.65
15140.54
15159.16
15166.98
15180.97
15201.03
15229.15
15240.03
15250.33
15260.63
15270.98
15286.87
15302.64
15321.46
15338.57
15345.95
15364.12
15377.10
15385.38
15400.33
15413.60
15423.84
15441.70
15451.03
15465.03
15477.94
15491.90
15506.40
15520.50
15534.83
15551.18
15571.97
15591.70
15609.08
15618.07
15634.43
15648.51
15660.07
15668.17
15676.34
15690.07
15707.29
15717.91
15728.22
15743.57
15752.02
15761.73
15774.07
15789.95
15817.88
15840.21
15865.88
15881.52
15901.77
15921.70
15931.99
15940.22
15963.74
16000.78
16023.32
16043.80
16063.46
16077.67
16086.82
16105.74
16128.22
16142.93
16159.83
16176.29
16186.62
16207.26
16220.73
16249.42
16269.93
16291.41
16312.82
16331.52
16355.80
16385.56
16401.18
16433.17
16446.03
16455.11
16470.83
16494.83
16515.32
16532.23
16547.02
16556.90
16569.96
16585.81
16599.13
16617.50
16630.27
16642.09
16653.43
16666.54
16680.77
16691.55
16715.28
16734.54
16746.54
16763.81
16780.51
16806.21
16821.39
16831.43
16850.08
16865.97
16878.90
16897.69
16910.48
16921.92
16939.60
16955.56
16967.04
16977.90
16995.97
17016.50
17038.64
17059.51
17086.32
17105.15
17127.12
17138.94
17150.37
17165.22
17186.42
17202.33
17215.12
17267.65
17289.48
17305.99
17330.88
17344.88
17368.19
17395.72
17419.81
17430.14
17439.39
17449.07
17472.94
17491.05
17503.68
17558.57
17571.10
17590.51
17601.88
17623.48
17636.21
17657.85
17677.86
17696.03
17776.40
17793.87
17813.85
17828.16
17842.48
17861.04
17883.74
17902.08
17925.32
17957.30
17977.54
18001.11
18011.46
18027.80
18051.11
18085.22
18108.20
18121.09
18161.76
18183.02
18204.64
18234.10
18259.18
18283.36
18311.33
18333.95
18356.20
18380.08
18393.89
18411.80
18459.82
18477.65
18504.82
18530.51
18591.76
18615.71
18630.97
18644.61
18669.62
18690.96
18708.36
18723.27
18742.14
18774.44
18790.47
18813.57
18838.92
18857.45
18874.15
18900.85
18932.00
18983.91
19013.54
19049.46
19068.76
19090.87
19112.66
19132.40
19156.89
19169.91
19196.85
19247.91
19283.01
19309.63
19324.10
19337.12
19393.21
19432.36
19444.31
19468.80
19499.63
19533.25
19558.66
19582.41
19612.80
19633.56
19661.08
19694.84
19730.91
19783.91
19824.99
19852.13
19879.41
19899.39
19919.82
19937.12
19951.82
19967.41
20018.90
20035.33
20085.41
20105.84
20164.10
20187.60
20211.92
20239.18
20262.40
20279.52
20300.93
20336.51
20373.85
20397.31
20412.22
20498.11
20533.28
20547.75
20577.94
20619.70
20640.39
20657.18
20697.20
20750.43
20800.19
20856.44
20877.48
20948.61
20970.63
21003.36
21053.71
21082.96
21111.63
21181.96
21208.46
21249.65
21272.12
21295.11
21336.49
21400.55
21429.32
21451.92
21478.44
21513.16
21545.01
21587.21
21621.32
21641.08
21724.78
21752.41
21776.02
21833.48
21872.68
21920.34
22003.32
22042.97
22106.28
22198.43
22235.32
22281.82
22314.00
22351.79
22392.03
22425.91
22467.06
22500.03
22522.30
22585.61
22620.46
22741.20
22814.15
22852.96
22909.25
22999.68
23045.33
23187.30
23223.56
23263.90
23288.42
23402.84
23437.59
23479.48
23507.03
23551.79
23588.38
23612.33
23646.04
23680.48
23707.52
23812.66
23843.75
23878.89
23932.17
24012.76
24042.28
24093.05
24180.24
24233.88
24267.91
24305.19
24422.87
24590.98
24658.45
24886.03
24925.21
24956.47
25200.43
25371.89
25409.10
25487.72
25544.81
25583.42
25639.25
25699.96
25838.88
25892.55
25926.90
25951.15
25976.35
26006.76
26147.35
26325.93
26541.84
26664.91
26755.99
26804.25
26838.68
26864.30
26948.97
27000.27
27114.14
27519.82
27577.14
27700.21
27972.94
28101.79
28174.21
28304.66
28512.26
28596.77
28732.48
28891.36
28976.55
29089.78
29181.73
29665.27

TABLE S8
Peak list for the SimulTOF100 consisting of 1256 peaks.

3023.81
3044.41
3063.74
3073.50
3088.91
3111.73
3142.77
3153.94
3168.21
3179.35
3202.34
3218.78
3242.75
3266.26
3292.17
3318.13
3334.86
3367.23
3398.13
3422.99
3431.74
3446.26
3467.03
3484.77
3497.59
3510.51
3555.38
3582.41
3592.95
3612.67
3645.54
3665.97
3680.98
3692.81
3705.82
3725.12
3737.29
3757.69
3778.03
3804.20
3811.16
3823.73
3831.71
3843.01
3867.87
3875.27
3892.40
3908.68
3923.71
3935.75
3955.82
3967.68
3979.17
3989.64
4012.99
4033.40
4052.15
4077.30
4088.90
4102.00
4122.29
4134.49
4154.25
4173.58
4186.52
4197.23
4209.59
4216.53
4230.56
4240.08
4251.74
4265.68
4289.97
4307.97
4316.15
4342.58
4355.45
4361.71
4383.46
4391.94
4406.18
4418.37
4435.49
4442.80
4458.66
4470.23
4487.22
4508.97
4521.16
4537.23
4547.71
4566.83
4586.66
4598.41
4613.77
4627.63
4644.35
4666.75
4676.43
4688.85
4698.77
4711.59
4723.37
4737.61
4756.33
4776.68
4790.70
4815.49
4823.51
4831.57
4839.80
4856.73
4870.38
4880.37
4892.61
4910.97
4923.42
4938.12
4961.54
4973.11
4979.80
4997.37
5023.73
5034.83
5044.88
5054.96
5068.88
5077.76
5095.59
5107.54
5117.48
5129.09
5142.83
5151.64
5157.18
5176.91
5195.87
5206.08
5223.54
5231.12
5250.33
5267.27
5275.15
5291.35
5308.43
5316.85
5321.99
5327.21
5336.33
5344.02
5362.27
5375.13
5381.06
5393.90
5407.51
5419.30
5430.24
5452.15
5461.05
5473.53
5493.60
5504.62
5511.98
5522.54
5536.06
5556.81
5574.29
5585.97
5600.64
5614.99
5619.75
5630.55
5635.81
5643.88
5657.78
5663.26
5677.53
5685.81
5697.80
5708.35
5719.95
5735.65
5751.55
5764.10
5778.03
5794.17
5801.44
5812.68
5823.15
5841.90
5853.08
5864.03
5878.19
5884.16
5890.12
5896.37
5909.74
5920.83
5928.35
5937.29
5955.41
5965.89
5988.52
6007.68
6028.37
6046.90
6064.12
6077.38
6088.79
6095.40
6109.57
6122.72
6141.99
6148.05
6153.82
6174.21
6187.31
6196.51
6212.04
6225.90
6233.39
6244.98
6254.24
6275.41
6286.77
6299.03
6310.83
6317.44
6332.29
6344.28
6350.41
6356.97
6369.46
6389.13
6399.36
6421.40
6433.04
6443.52
6453.70
6472.68
6481.77
6494.28
6516.78
6531.52
6540.92
6556.30
6565.17
6587.09
6595.25
6623.54
6631.39
6641.41
6652.13
6666.07
6671.88
6682.75
6687.77
6693.68
6720.43
6729.54
6739.39
6751.41
6757.85
6774.27
6785.06
6794.61
6806.88
6815.14
6837.92
6858.87
6871.48
6881.02
6895.92
6903.33
6909.16
6921.52
6928.95
6940.54
6954.18
6961.15
6968.65
6985.57
6993.09
6999.82
7022.62
7033.88
7044.49
7055.35
7065.31
7072.08
7084.18
7091.47
7096.63
7101.40
7127.20
7137.82
7146.62
7151.34
7156.71
7164.76
7176.07
7187.51
7202.06
7215.80
7244.05
7251.64
7259.34
7270.68
7287.77
7299.24
7306.78
7311.88
7318.38
7331.83
7343.94
7356.70
7375.66
7389.02
7398.48
7416.92
7425.32
7437.91
7451.76
7460.58
7469.80
7477.57
7483.87
7488.43
7497.21
7503.36
7508.49
7514.83
7521.00
7536.45
7553.18
7557.55
7563.70
7573.08
7584.92
7596.16
7607.01
7615.43
7628.66
7647.64
7653.43
7666.92
7676.86
7690.10
7696.38
7709.25
7715.29
7721.24
7737.52
7747.51
7758.20
7768.73
7781.66
7799.61
7811.59
7822.21
7829.63
7839.84
7847.39
7852.88
7867.73
7877.91
7897.96
7912.71
7934.18
7944.90
7955.32
7959.88
7965.16
7979.90
7992.88
7997.83
8015.52
8025.91
8037.42
8047.12
8058.26
8065.84
8075.29
8088.40
8103.36
8119.65
8128.13
8139.94
8149.69
8159.04
8167.35
8172.01
8187.24
8191.97
8204.54
8216.91
8222.73
8230.12
8237.02
8244.58
8257.66
8268.51
8279.50
8285.58
8294.01
8304.16
8314.08
8327.31
8334.99
8340.67
8346.18
8360.44
8370.26
8388.44
8410.51
8427.55
8442.58
8448.43
8462.93
8474.97
8487.70
8500.67
8513.06
8520.93
8528.39
8545.37
8554.72
8563.30
8571.97
8581.23
8592.31
8615.38
8626.71
8637.82
8657.07
8682.70
8691.85
8701.89
8712.10
8724.31
8739.63
8752.36
8765.88
8785.63
8791.08
8796.47
8801.53
8810.93
8822.01
8826.50
8838.84
8848.06
8859.27
8868.42
8891.39
8915.96
8927.45
8933.91
8946.68
8953.09
8959.01
8973.21
8980.82
8995.80
9017.64
9026.20
9034.43
9048.33
9062.17
9070.94
9076.79
9084.76
9095.34
9107.13
9123.98
9135.14
9152.93
9165.39
9177.19
9183.31
9192.45
9203.65
9213.27
9222.12
9241.33
9261.77
9279.37
9287.56
9293.67
9302.78
9316.84
9325.99
9352.49
9361.52
9373.47
9387.98
9394.49
9412.24
9422.82
9427.55
9436.04
9445.47
9453.56
9462.29
9480.96
9487.18
9501.31
9507.70
9512.41
9529.85
9538.34
9557.64
9573.85
9585.83
9597.12
9623.28
9629.58
9645.64
9660.09
9668.82
9687.41
9701.70
9714.05
9727.56
9736.84
9746.34
9757.68
9775.66
9789.57
9797.66
9806.36
9816.46
9834.47
9852.36
9861.39
9870.51
9879.33
9891.22
9904.39
9919.34
9935.11
9949.88
9955.27
9963.58
9969.79
9981.61
9992.01
10005.54
10011.56
10018.75
10024.30
10034.00
10049.13
10058.47
10064.03
10071.50
10079.97
10085.15
10099.13
10110.35
10118.77
10125.23
10130.20
10137.19
10147.56
10155.58
10172.58
10181.39
10191.16
10198.24
10208.31
10213.01
10218.96
10225.77
10232.79
10244.73
10251.86
10259.99
10271.34
10276.39
10283.00
10291.99
10300.52
10308.93
10317.96
10323.93
10334.34
10342.10
10352.73
10360.98
10371.92
10378.07
10384.35
10391.37
10401.90
10411.25
10421.56
10429.52
10437.33
10445.98
10458.00
10468.46
10477.04
10491.07
10505.77
10515.81
10525.08
10532.48
10546.72
10557.81
10567.31
10581.70
10593.12
10600.05
10607.49
10613.50
10623.28
10632.85
10646.35
10663.77
10675.42
10680.53
10688.13
10695.45
10701.36
10708.43
10726.70
10735.10
10745.46
10751.67
10771.77
10780.79
10789.39
10795.98
10801.49
10811.00
10829.65
10836.72
10851.96
10872.41
10878.95
10887.38
10902.79
10912.64
10920.45
10929.39
10934.29
10944.16
10956.44
10963.16
10968.06
10979.12
10991.44
11000.24
11007.63
11017.02
11026.18
11044.35
11059.40
11066.08
11070.83
11078.51
11088.24
11095.21
11101.41
11107.68
11125.98
11137.61
11147.86
11158.48
11163.59
11169.71
11176.06
11188.02
11193.01
11204.25
11217.05
11226.74
11233.81
11245.41
11255.65
11263.86
11277.47
11289.56
11302.92
11312.67
11317.28
11339.94
11352.60
11362.04
11370.72
11379.83
11388.81
11395.76
11408.05
11434.22
11443.30
11450.69
11458.08
11466.52
11478.13
11484.01
11498.14
11506.46
11513.70
11518.63
11530.28
11540.65
11550.19
11566.50
11572.34
11582.69
11591.43
11600.23
11606.76
11628.16
11651.76
11676.53
11682.58
11697.46
11705.01
11712.67
11721.33
11730.60
11741.68
11750.28
11763.43
11783.63
11794.07
11808.84
11829.33
11839.10
11846.96
11861.84
11871.63
11877.31
11891.01
11906.56
11919.14
11938.34
11952.76
11968.34
11980.30
11988.72
11998.19
12005.62
12010.72
12026.62
12039.90
12050.87
12062.40
12072.56
12083.79
12089.10
12094.84
12107.07
12114.95
12120.80
12129.80
12138.62
12148.81
12154.84
12161.22
12167.40
12174.22
12180.73
12196.82
12205.97
12212.52
12230.53
12238.42
12248.43
12258.30
12273.83
12280.73
12295.00
12312.88
12340.76
12350.86
12366.32
12374.45
12383.24
12391.96
12403.83
12411.08
12435.84
12454.26
12467.06
12485.23
12491.63
12503.31
12513.03
12519.54
12542.40
12558.09
12567.55
12573.82
12589.22
12608.21
12624.71
12635.10
12641.03
12656.84
12672.27
12689.91
12707.30
12734.02
12744.68
12754.30
12769.17
12780.24
12795.60
12849.06
12857.30
12865.01
12879.06
12891.28
12905.53
12914.53
12923.75
12933.20
12948.66
12963.47
12979.10
12991.38
13007.11
13030.24
13046.65
13060.40
13069.36
13088.39
13104.12
13109.62
13115.26
13130.02
13154.57
13168.89
13178.52
13188.85
13205.15
13216.19
13231.48
13245.58
13259.62
13273.35
13291.50
13297.45
13315.73
13335.09
13344.50
13358.54
13372.47
13388.78
13399.57
13410.57
13429.28
13455.28
13469.94
13479.24
13486.42
13498.16
13507.65
13525.78
13538.28
13559.11
13568.18
13578.13
13588.06
13595.30
13608.80
13628.21
13637.38
13651.74
13660.34
13678.51
13687.35
13700.55
13723.73
13747.90
13762.96
13778.07
13792.38
13804.35
13810.37
13824.12
13842.89
13869.14
13881.83
13899.99
13911.55
13926.61
13938.62
13977.14
13993.57
14029.31
14041.72
14057.76
14069.96
14090.21
14106.43
14117.41
14138.70
14149.21
14167.71
14194.97
14218.34
14229.76
14254.19
14274.02
14296.08
14308.21
14327.58
14342.34
14355.99
14369.82
14379.64
14403.22
14421.73
14437.88
14451.55
14462.48
14473.04
14485.29
14498.74
14512.64
14529.37
14545.23
14563.09
14570.34
14583.17
14598.41
14630.28
14641.85
14656.02
14668.79
14693.07
14704.19
14717.37
14728.57
14738.85
14751.93
14767.25
14780.35
14794.69
14808.63
14818.77
14832.17
14845.03
14860.15
14878.48
14898.96
14914.02
14931.67
14940.63
14953.82
14972.04
14987.38
15005.88
15020.22
15038.71
15045.48
15053.87
15074.85
15128.49
15146.32
15165.79
15180.43
15207.42
15217.48
15227.33
15247.13
15277.94
15292.68
15313.23
15325.12
15334.40
15352.17
15371.02
15394.02
15409.92
15418.39
15436.45
15452.03
15471.85
15485.24
15501.05
15513.73
15530.66
15539.63
15558.76
15576.48
15604.42
15627.53
15646.20
15659.78
15675.28
15692.63
15709.04
15719.44
15732.55
15744.69
15758.79
15776.37
15869.80
15890.70
15915.82
15947.19
15967.18
15987.99
16010.26
16033.45
16054.40
16075.80
16094.11
16114.60
16132.75
16150.94
16176.02
16197.52
16217.31
16236.56
16259.24
16281.63
16301.17
16317.77
16339.78
16347.99
16368.99
16392.04
16434.61
16457.01
16483.32
16504.56
16523.52
16534.38
16556.93
16634.10
16651.92
16661.03
16672.56
16692.64
16711.05
16736.89
16775.90
16795.38
16814.61
16824.85
16837.37
16868.42
16885.71
16898.19
16916.81
16929.40
16948.31
16963.03
16984.62
16998.35
17024.39
17038.98
17050.93
17066.47
17086.12
17105.70
17125.82
17151.93
17175.38
17198.37
17226.58
17253.95
17277.10
17310.57
17332.61
17360.43
17381.97
17407.88
17434.97
17460.77
17479.35
17491.04
17548.46
17590.01
17610.37
17626.71
17643.24
17654.27
17669.91
17682.14
17699.40
17729.30
17751.99
17772.56
17792.59
17804.16
17827.45
17844.64
17873.99
17891.36
17911.45
17960.03
17983.85
18016.28
18040.00
18061.88
18080.85
18098.57
18126.82
18145.45
18170.40
18191.80
18211.37
18238.77
18269.58
18290.27
18338.74
18369.56
18389.18
18418.11
18441.89
18474.73
18496.65
18555.68
18572.75
18598.67
18611.75
18629.85
18654.26
18708.90
18725.60
18756.72
18796.92
18839.78
18858.47
18893.00
19021.89
19039.04
19054.77
19079.28
19093.95
19142.31
19240.76
19278.06
19310.09
19377.97
19435.37
19451.06
19469.51
19502.69
19562.55
19593.10
19672.00
19725.43
19776.10
19814.18
19833.29
19851.06
19891.29
19911.28
19933.45
19975.88
19989.33
20033.11
20071.40
20162.91
20197.18
20324.42
20356.18
20395.18
20513.05
20538.45
20576.65
20603.92
20634.89
20654.67
20767.09
20794.42
20835.26
20927.52
20957.98
20974.81
21039.39
21065.63
21107.57
21165.46
21267.61
21368.85
21400.32
21451.11
21474.89
21570.97
21609.06
21705.78
21756.33
21803.77
21852.46
21909.01
21980.40
22024.60
22084.70
22189.95
22223.59
22260.52
22296.83
22323.48
22351.04
22388.85
22425.11
22465.33
22498.41
22529.32
22550.44
22605.63
22707.75
22798.92
22830.64
22909.04
22967.33
23030.92
23134.10
23169.62
23250.10
23316.23
23354.17
23463.84
23557.18
23667.26
23805.39
23846.17
24118.20
24645.21
25185.27
25274.04
25402.98
25477.33
25558.75
25613.20
25674.54
25800.92
25898.64
25947.39
26861.45
27406.52
27564.84
27965.03
28094.69
28191.16
28299.46
28402.00
28511.56
28611.98
28716.59
28879.68
28971.42
29082.43
29188.23
29287.76
29656.50

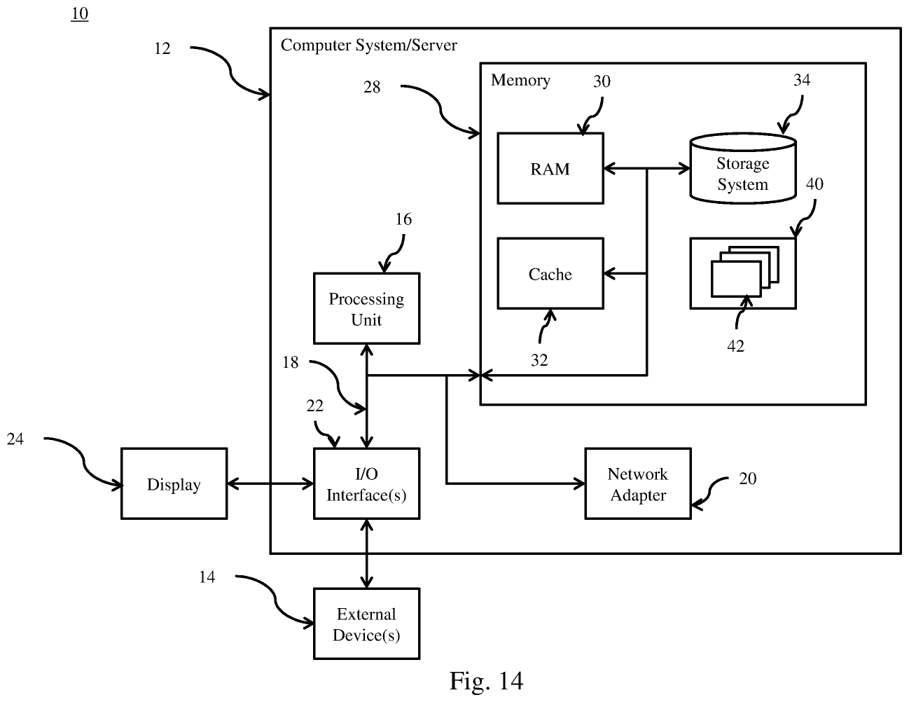

Referring now to FIG. 14, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 14, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media. System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Various examples of learning systems are provided herein. In general, a feature vector is provided to such a learning system. Based on the input features, the learning system generates one or more outputs, such as a disease indication. In some embodiments, the output of the learning system is itself feature vector.

In some embodiments, the learning system comprises a SVM. In other embodiments, the learning system comprises an artificial neural network. However, it will be appreciated that a variety of other classifiers are suitable for use according to the present disclosure, including linear classifiers, support vector machines (SVM), or neural networks such as recurrent neural networks (RNN). Additional embodiments include logistic regression-based models, such as elastic net, ridge regression, and LASSO, and decision tree-based models, such as xgBoost.

In some embodiments, the learning system is pre-trained using training data. In some embodiments training data is retrospective data. In some embodiments, the retrospective data is stored in a data store. In some embodiments, the learning system may be additionally trained through manual curation of previously generated outputs.

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

When creating molecular diagnostic tests, it is often the case that the length of the feature vector, i.e., the number of attributes available for training, is greater than the size of the training set. This is known as the “p>N problem” or the curse of dimensionality. Not all learning systems perform well in this setting and they may overfit to the training data and produce tests that do not generalize to unseen datasets. When working in this situation, a suitable embodiment of the learning system should be chosen. Generally, ensemble learning methods may be well-suited to this setting, and one common embodiment thereof is the Random Forest ensemble of decision trees. In addition, one further embodiment specifically designed to be used in case when the number of attributes is greater than the size of the training set is the Diagnostic Cortex learning platform, a hierarchical structure of classifiers incorporating ensemble averaging, which has been shown to produce robust classifiers for molecular diagnostic tests when the number of available attributes is of the order of or exceeds the size of the training set without overfitting to the training data. Further discussion of the Diagnostic Cortex learning platform is provided, e.g., in U.S. Pat. No. 9,779,204, which is hereby incorporated by reference in its entirety.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of extracting a plurality of feature values from a mass spectrum, the method comprising:
reading a mass spectrum of a sample originating from a matrix-assisted laser desorption/ionization (MALDI) mass spectrometer;
reading a peak shape function of the mass spectrometer;
determining a fine structure component for a first range of the mass spectrum, wherein determining the fine structure component comprises
estimating a first background of the mass spectrum,
subtracting the first background from the mass spectrum;
determining a bump structure for the first range of the mass spectrum, wherein
determining the bump structure component comprises
estimating a second background of the mass spectrum, the second background being stiffer than the first background;
subtracting the second background from the first background;
computing a convolution of the fine structure component for the first range of the mass spectrum with the peak shape function;
determining a first plurality of peaks in the first range of the mass spectrum from the convolution;
determining a feature value indicative of an abundance associated with each of the first plurality of peaks, wherein determining the feature value comprises combining the first plurality of peaks with the bump structure.

2. The method of claim 1, further comprising:
reading a reference peak list comprising a plurality of reference peaks;
aligning the first plurality of peaks to the plurality of reference peaks.

3. The method of claim 1, further comprising:
reading a reference peak list comprising a plurality of reference peaks;
determining a second plurality of peaks in the mass spectrum by fitting the peak shape function to each of the plurality of reference peaks.

4. The method of claim 1, wherein estimating the first and/or second background comprises applying an asymmetric least squares fitting.

5. The method of claim 4, wherein estimating the first and/or second background comprises applying Eilers' estimation.

6. The method of claim 1, further comprising:
determining a peak amplitude for each of the first plurality of peaks, wherein combining the first plurality of peaks with the bump structure comprises
combining the peak amplitude and an intensity of the bump structure.

7. The method of claim 1, further comprising:
determining a peak area for each of the first plurality of peaks, wherein combining the first plurality of peaks with the bump structure comprises
combining the peak area and an area of the bump structure.

8. The method of claim 1, wherein the peak shape function is an asymmetric Gaussian.

9. The method of claim 8, wherein reading the peak shape function comprises reading a plurality of coefficients of the asymmetric Gaussian.

10. The method of claim 8, wherein determining the first plurality of peaks comprises:
simultaneously fitting the peak shape function to a plurality of peak candidates in parallel.

11. The method of claim 8, wherein determining the first plurality of peaks comprises:
identifying a plurality of clusters of candidate peaks;
simultaneously fitting the peak shape function to each peak candidates in at least one of the plurality of clusters in parallel.

12. The method of claim 11, wherein identifying the plurality of clusters comprises:
selecting candidate peaks having peak centers within a predetermined distance of each other.

13. The method of claim 12, wherein the predetermined distance is a half peak-width.

14. The method of claim 11, wherein identifying the plurality of clusters comprises:
selecting candidate peaks intersecting each other at greater than a threshold amplitude.

15. The method of claim 12, wherein the threshold amplitude is a predetermined fraction of a maximum amplitude.

16. The method of claim 15, wherein the predetermined fraction is 10%.

17. The method of claim 1, wherein determining the first plurality of peaks comprises filtering candidate peaks according to a predetermined SNR threshold.

18. The method of claim 1, wherein determining the first plurality of peaks comprises performing median absolute deviation (MAD) fitting.

19. The method of claim 1, wherein the MALDI mass spectrometer is a MALDI-time-of-flight (MALDI-TOF) mass spectrometer.

20. The method of claim 19, wherein reading the mass spectrum comprises performing Deep MALDI.

21. The method of claim 1, wherein each feature value corresponds to peak amplitude.

22. The method of claim 1, further comprising:
estimating a baseline background of the mass spectrum and subtracting the background therefrom.

23. The method of claim 22, wherein estimating the baseline background comprises applying an asymmetric least squares fitting.

24. The method of claim 23, wherein estimating the baseline background comprises applying Eilers' estimation.

25. A computer-implemented method of disease detection, comprising:
determining a plurality of feature values from a mass spectrum according to a method of claim 1, wherein the sample is a biological sample of a subject;
providing the plurality of feature values to a trained classifier, and receiving therefrom an indication of the presence of a disease condition in the subject.

26. A computer-implemented method of training a classifier, comprising:
determining a plurality of feature values from a mass spectrum according to a method of claim 1, wherein the sample is a biological sample of a subject;
training a classifier to provide an indication of the presence of a disease condition in the subject based on the plurality of feature values.

27. A system comprising:
a mass spectrometer;
a computing node operatively coupled to the mass spectrometer and comprising a computer readable storage medium having program instructions embodied therewith, the program instructions executable by a processor of the computing node to cause the processor to perform a method according to claim 1.

28. A computer program product for extracting a plurality of feature values from a mass spectrum, the computer program product comprising a computer readable storage medium having program instructions embodied therewith, the program instructions executable by a processor to cause the processor to perform a method according to claim 1.
